(19) United States
(12) Patent Application Publication
(10) Pub. No.: US 2020/0326576 A1
(43) Pub. Date: Oct. 15, 2020

(54) DISPLAY PANEL AND DISPLAY DEVICE

(71) Applicant: SHARP KABUSHIKI KAISHA, Osaka (JP)

(72) Inventors: SHINGO KAMITANI, Osaka (JP); SHINGO JOHGAN, Osaka (JP); JUNICHI MORINAGA, Osaka (JP); HIKARU YOSHINO, Osaka (JP)

(21) Appl. No.: 16/843,448

(22) Filed: Apr. 8, 2020

(30) Foreign Application Priority Data
Apr. 11, 2019 (JP) 2019-075527

(51) Int. Cl. G02F 1/1339; G02F 1/1362

(52) U.S. Cl. CPC G02F 1/13394; G02F 2001/1351; G02F 1/1362

(57) ABSTRACT

A display panel includes: a pair of substrates provided opposite each other with a substrate-to-substrate distance between the substrates; a plurality of pixels arranged in a matrix, the pixels including pixel sections; inter-pixel-section light-blocking sections providing partitions between the pixel sections; spacers arranged, between the substrates, in locations over the inter-pixel-section light-blocking sections; and extended light-blocking sections provided so as to extend inward of the pixel sections from the inter-pixel-section light-blocking sections, wherein the spacers include: first spacers regulating the substrate-to-substrate distance; and second spacers and third spacers projecting from the substrate toward the substrate, the second spacers and third spacers having a projection length smaller than the substrate-to-substrate distance, the third spacers having a smaller footprint than do the second spacers.

### CROSS-REFERENCE TO RELATED APPLICATION

The present disclosure contains subject matter related to that disclosed in Japanese Priority Patent Application 2019-075527 filed in the Japan Patent Office on Apr. 11, 2019, the entire contents of which are hereby incorporated by reference.

### FIELD OF THE INVENTION

The subject technology relates to display panels and display devices.

### BACKGROUND OF THE INVENTION

A conventional display panel includes: a pair of substrates disposed opposite each other with a prescribed substrate-to-substrate distance therebetween; and a plurality of types of spacers interposed between these substrates. Among the spacers, main spacers are provided between, and in contact with, both the substrates. Subspacers project from one of the substrates toward the other substrate, leaving clearance between the subspacers and the other substrate. For instance, Japanese Unexamined Patent Application Publication, Tokukai, No. 2008-46624 discloses a color filter manufacturing method by which a half tone mask (grayscale mask) and a slit pattern are combined to form columnar spacers having, for example, different projection lengths like those types of spacers described here.

### SUMMARY OF THE INVENTION

### Problems to be Solved by the Invention

An improper display tends to occur in regions over and around spacers in the display panel. These regions are covered by providing spacer light-blocking sections to block light transmission for the purpose of maintaining high image display quality. The display panel further includes inter-pixel-section light-blocking sections for providing partitions between image-displaying pixel sections. The spacers are typically disposed in locations over the inter-pixel-section light-blocking sections in a plan view. The parts of the spacer light-blocking sections that are not contained in the inter-pixel-section light-blocking sections are formed as extended light-blocking sections that are inward extensions of pixel sections facing spacers from the inter-pixel-section light-blocking sections containing the spacers. The pixel sections provided with these extended light-blocking sections have a reduced aperture ratio and therefore reduced luminance.

The main spacers, in particular, need a large spacer light-blocking section. Therefore, there are provided large extended light-blocking sections in pixel sections facing the main spacers. The aperture ratio hence falls in these pixel sections, causing significant local decreases in luminance that will likely be visually recognized as irregular luminance on the display screen. A feasible design addressing these issues is to deliberately reduce the aperture ratio to make irregular luminance less recognizable, for example, by appropriately providing extended light-blocking sections (dummies) in locations containing no spacers in the parts of the pixel sections not facing the main spacers and/or by forming those extended light-blocking sections related to subspacers with such large dimensions that the extended light-blocking sections can accommodate dummy regions (dummies). This design, where there are provided extended light-blocking sections (dummies) in addition to extended light-blocking sections for covering the spacers and their surrounding regions, however, seriously reduces the aperture ratio across the entire display panel, which leads to significant decreases in luminance across the entire display screen.

The subject technology, developed in view of these and other issues, has an object to provide a display panel having excellent surface pressure resistance and image display quality and being capable of suppressing decrease in luminance. The subject technology has another object to provide a display device that includes such a display panel.

### Solution to the Problems

(1) The present specification discloses technology an embodiment of which is directed to a display panel including: a pair of substrates provided opposite each other with a prescribed substrate-to-substrate distance between the substrates; a plurality of pixels arranged in a matrix on a face of the substrates, the pixels including pixel sections including at least first pixel sections that give off a specific color and second pixel sections that give off a different color from the specific color; inter-pixel-section light-blocking sections provided on at least one of the substrates in such a manner as to provide partitions between adjacent pixel sections; spacers arranged, between the substrates, in locations over the inter-pixel-section light-blocking sections when viewed normal to the substrates; and extended light-blocking sections provided so as to extend inward of the pixel sections from the inter-pixel-section light-blocking sections, to shield regions surrounding the spacers from light, wherein the spacers include: first spacers interposed between the substrates in such a manner as to be in contact with both the substrates when in a natural state, to regulate the substrate-to-substrate distance; at least one second spacer provided on at least one of the substrates so as to project toward the other substrate, the at least one second spacer having a projection length smaller than the substrate-to-substrate distance; and third spacers provided on at least one of the substrates so as to project toward the other substrate, the third spacers having a projection length smaller than the substrate-to-substrate distance and having a smaller footprint than does the at least one second spacer when viewed normal to the substrates.
(2) The present specification discloses technology another embodiment of which is directed to a display panel configured as in (1) above and configured further such that: the first spacers are provided so as to assume prescribed positions relative to the pixel sections when viewed normal to the substrates; and the at least one second spacer includes a plurality of second spacers some of which are arranged so as to assume the prescribed positions relative to the pixel sections when viewed normal to the substrates.
(3) The present specification discloses technology yet another embodiment of which is directed to a display panel configured as in (2) above and configured further such that more than half of the second spacers are arranged so as to assume the prescribed positions relative to the pixel sections when viewed normal to the substrates.
(4) The present specification discloses technology still another embodiment of which is directed to a display panel configured as in any of (1) to (3) above and configured further such that the pixel sections include at least two pixel sections arranged next to each other in a row direction and at least two pixel sections arranged next to each other in a column direction; the inter-pixel-section light-blocking sections are arranged to form a lattice; among the spacers, at least the first spacers and the at least one second spacer are provided at intersecting portions of the inter-pixel-section light-blocking sections; and the extended light-blocking sections for the first spacers and the at least one second spacer are provided so as to extend inward of four of the pixel sections adjacent to the intersecting portions.
(5) The present specification discloses technology yet still another embodiment of which is directed to a display panel configured as in any of (1) to (4) above and configured further such that the third spacers outnumber the at least one second spacer.
(6) The present specification discloses technology a further embodiment of which is directed to a display panel configured as in any of (1) to (5) above and configured further such that among the pixel sections, the first pixel sections and the second pixel sections are repeatedly arranged in a prescribed order in a row direction, whereas either the first pixel sections or the second pixel sections are repeatedly arranged in a column direction; and the at least one second spacer and the third spacers are arranged in a fixed manner in the row and column directions of the pixel sections, to form a lattice.
(7) The present specification discloses technology yet a further embodiment of which is directed to a display panel configured as in any of (1) to (5) above and configured further such that among the pixel sections, the first pixel sections and the second pixel sections are repeatedly arranged in a prescribed order in a row direction, whereas either the first pixel sections or the second pixel sections are repeatedly arranged in a column direction; and the at least one second spacer and the third spacers are arranged in a fixed manner in the row direction of the pixel sections and in a staggered manner by being displaced by a prescribed amount in the column direction.
(8) The present specification discloses technology still a further embodiment of which is directed to a display panel configured as in (6) or (7) above and configured further such that the first spacers are provided in locations where some of the at least one second spacer are replaced.
(9) The present specification discloses technology yet still a further embodiment of which is directed to a display panel configured as in any of (1) to (8) above and configured further such that those inter-pixel-section light-blocking sections that are adjacent to the pixel sections facing the first spacers include no second spacer.
(10) The present specification discloses technology an additional embodiment of which is directed to a display panel configured as in any of (1) to (9) above and configured further such that for each of the pixels, a fixed total number of the first spacers and the at least one second spacer is provided in the inter-pixel-section light-blocking section adjacent to the pixel sections in that pixel.
(11) The present specification discloses technology another embodiment of which is directed to a display panel configured as in any of (1) to (10) above and configured further such that the pixel sections further include third pixel sections that give off a different color than do the first pixel sections and the second pixel sections; the first pixel sections contribute more to panel transmittance than do the second pixel sections and the third pixel sections; and the first spacers are provided in those inter-pixel-section light-blocking sections that are adjacent to either the second pixel sections or the third pixel sections.
(12) The present specification discloses technology another embodiment of which is directed to a display panel configured as in (11) above and configured further such that the at least one second spacer is provided in those inter-pixel-section light-blocking sections that are adjacent to either the second pixel sections or the third pixel sections.
(13) The present specification discloses technology another embodiment of which is directed to a display device including the display panel configured as in any of (1) to (12).

### Advantageous Effects of the Invention

The subject technology provides a display panel having excellent surface pressure resistance and image display quality and being capable of suppressing decrease in luminance and also provides a display device that includes such a display panel.

### BRIEF DESCRIPTION OF DRAWINGS

FIG. 1 is a schematic plan view of a structure of a liquid crystal display device in accordance with Embodiment 1.

FIG. 2 is a schematic view of a cross-sectional structure of a liquid crystal panel between pixel sections.

FIG. 3 is a schematic view of an in-plane structure of an array substrate near a TFT.

FIG. 4 is a schematic view of an in-plane structure of a CF substrate.

FIG. 5 is a schematic view of an in-plane structure of a CF substrate provided only with a single type of subspacers in addition to main spacers in accordance with a comparative example.

FIG. 6 is a table of results of Verification Experiment 1.

FIG. 7 is a schematic view of an in-plane structure of a CF substrate in accordance with Embodiment 2.

FIG. 8 is a table of results of Verification Experiment 2.

FIG. 9 is a schematic view of an in-plane structure of a CF substrate in accordance with Embodiment 3.

FIG. 10 is a table of results of Verification Experiment 3.

FIG. 11 is a schematic view of an in-plane structure of a CF substrate in accordance with Embodiment 4.

FIG. 12 is a table of results of Verification Experiment 4.

FIG. 13 is a schematic view of an in-plane structure of a CF substrate in accordance with Embodiment 5.

FIG. 14 is a table of results of Verification Experiment 5.

FIG. 15 is a schematic view of an in-plane structure of a CF substrate in accordance with Embodiment 6.

FIG. 16 is a table of results of Verification Experiment 6.

FIG. 17 is a schematic plan view of a layout of spacers and a light-blocking layer in accordance with an example of another embodiment.

FIG. 18 is a schematic plan view of a layout of spacers and a light-blocking layer in accordance with another example of another embodiment.

FIG. 19 is a schematic plan view of a layout of spacers and a light-blocking layer in accordance with a further example of a further embodiment.

### DESCRIPTION OF EMBODIMENTS

### Embodiment 1

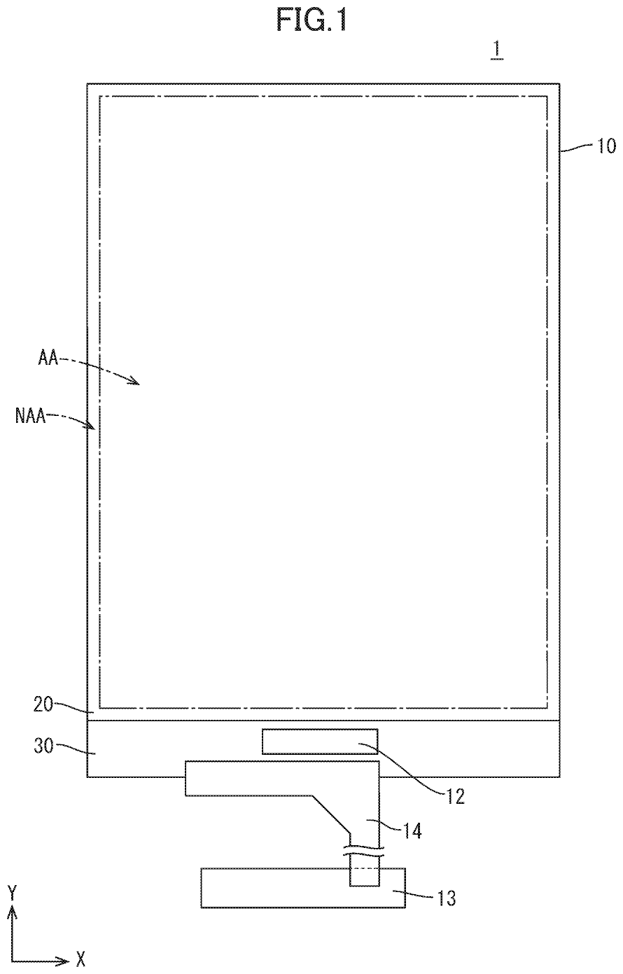

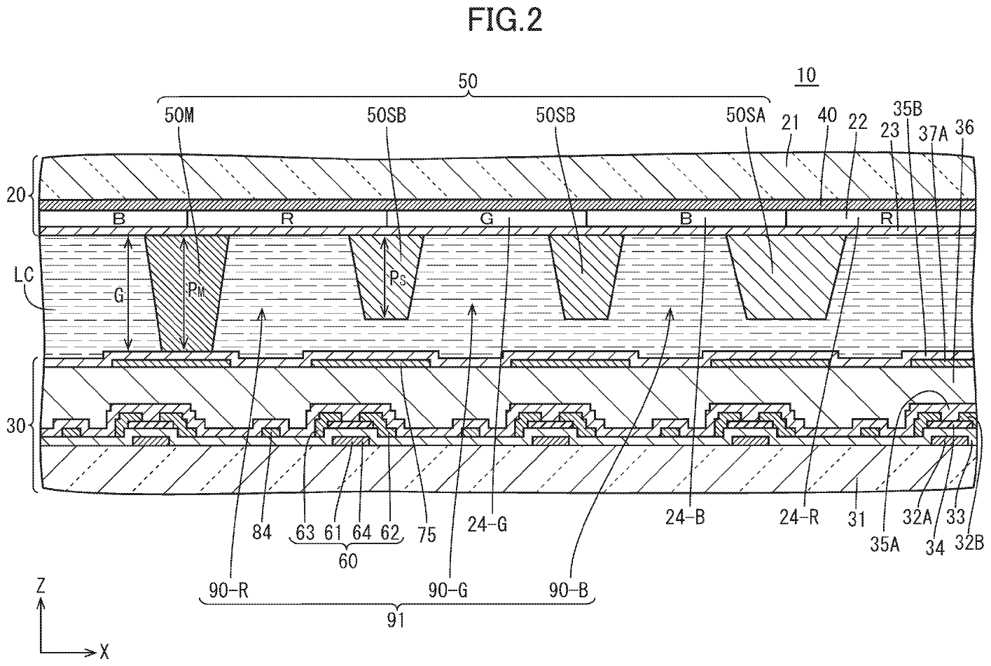

Embodiment 1 will be described now with reference to FIGS. 1 to 7. Present Embodiment 1 will take, as an example, a liquid crystal display device (an example of the display device) 1 including a liquid crystal panel (an example of the display panel) 10. Some of the figures show a common set of an X axis, a Y axis, and a Z axis and are drawn to match these axes. If a drawing includes identical members, a reference numeral may be indicated for only one of the members, and those for the other members may be omitted. The face of the liquid crystal display device 1 shown in FIG. 1, which coincides with the top side in FIG. 2, may be referred to as the front, and the bottom side in FIG. 2 as the rear, in the following description.

The liquid crystal display device 1 in accordance with present Embodiment 1 may be, for example, one of various electronic devices (not shown) including mobile phone terminals such as smartphones, laptop computers such as tablet computers, wearable terminals such as smart watches, mobile information terminals such as electronic books and PDAs, and mobile game machines. The liquid crystal panel 10 may generally be a “small- to smaller medium-sized” one that has a screen size of, for example, from a few to about a dozen inches. The subject technology is however not only applicable to these examples and can be applied to medium- to large (extra large)-sized display devices with a screen size of more than a few tens of inches.

FIG. 1 is a schematic plan view of a structure of the liquid crystal display device 1. As shown in the figure, the liquid crystal display device 1 includes: the liquid crystal panel 10 capable of displaying images; a driver (panel drive unit, driver circuit unit) 12 for driving the liquid crystal panel 10; a control circuit board (external signal supply source) 13 for externally supplying various input signals to the driver 12; and a flexible substrate (external connecting member) 14 for electrically connecting the liquid crystal panel 10 to the control circuit board 13. The driver 12 and flexible substrate 14 are mounted to the liquid crystal panel 10 via, for example, ACFs (anisotropic conductive films). The liquid crystal display device 1 further includes a backlight unit that is an external light source disposed on the rear of the liquid crystal panel 10 to illuminate the liquid crystal panel 10 with light for display.

Referring to FIG. 1, the liquid crystal panel 10 is shaped generally like a vertically elongated quadrilateral (rectangular). The liquid crystal panel 10 has a display area (active area) AA for displaying images in the central part of the front face thereof. The liquid crystal panel 10 further has a non-display area (non-active area) NAA along the periphery of the front face thereof surrounding the display area AA. The non-display area NAA is shaped like a frame in a plan view. Assume, throughout the following description, that the liquid crystal panel 10 has a short side parallel to the X-axis direction indicated in the figures, a long side parallel to the Y-axis direction indicated in the figures, and a thickness parallel to the Z-axis direction indicated in the figures. In FIG. 1, the display area AA has an external shape indicated by a dash-dot line, and the non-display area NAA is provided in the area outside the dash-dot line.

FIG. 2 is a schematic view of an exemplary cross-sectional structure of the liquid crystal panel 10. As shown in FIG. 2, the liquid crystal panel 10 includes at least transparent substrates 21 and 31 each composed of a thermally resistant, electrically insulating, and highly transparent glass or resin plate. Various layers (detailed later) are stacked in prescribed patterns on these transparent substrates 21 and 31. The transparent substrate 21, which is one of the transparent substrates 21 and 31 that is located on the front side, provides a CF substrate (opposite substrate) 20, and the transparent substrate 31, which is located on the rear side, provides an array substrate (thin film transistor substrate, active matrix substrate, or TFT substrate) 30. Between the CF substrate 20 and the array substrate 30 (a pair of substrates) is there provided a prescribed cell gap G where a liquid crystal layer LC is enclosed. The liquid crystal layer LC contains liquid crystal molecules, which are an electro-optical material that changes optical characteristics thereof in response to an applied electric field. The liquid crystal panel 10, in present Embodiment 1, is driven in FFS (fringe field switching) mode as an example. The transparent substrates 21 and 31 have a polarizer on outer faces thereof.

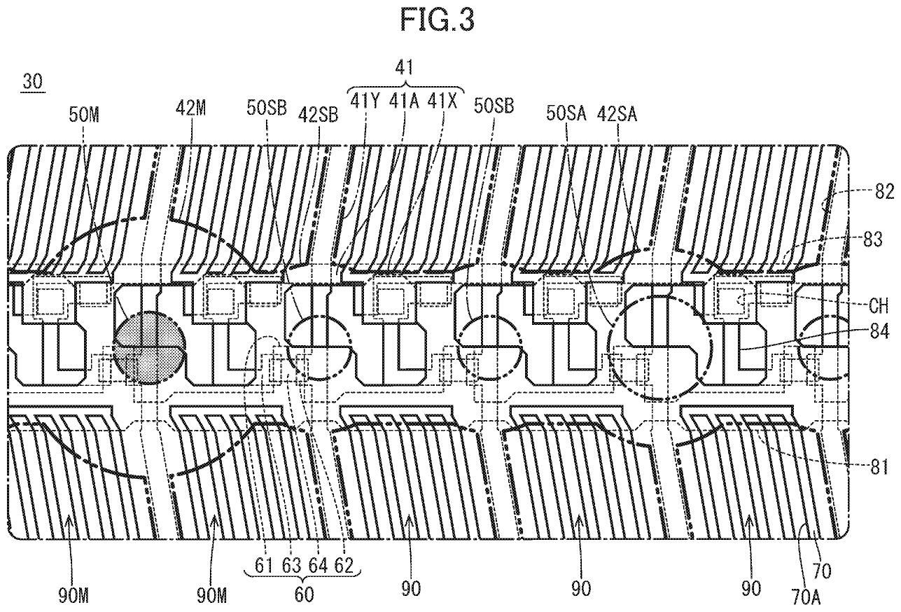

FIG. 3 is a schematic view of an exemplary in-plane structure of the array substrate 30. In FIG. 3, solid or dotted lines are used to indicate the structure of the array substrate 30, and imaginary lines (dash-dot or dash-double-dot lines) are used to indicate the structure of the CF substrate 20 placed over the array substrate 30. The inner face of the display area AA on the array substrate 30 (the face of the array substrate 30 where the array substrate 30 faces the liquid crystal layer LC and the CF substrate 20) has thereon a matrix of TFTs (switching elements) 60 and pixel electrodes 70 as shown in FIG. 3. The TFTs 60 and the pixel electrodes 70 are surrounded by a lattice of gate lines (scan lines) 81 and source lines (signal lines, data lines) 82. In other words, the TFTs 60 and the pixel electrodes 70 are provided near intersecting portions of the gate lines 81 and the source lines 82 forming a lattice in a plan view. The gate lines 81 extend linearly in the X-axis direction, whereas the source lines 82 extend in a zigzag manner generally in the Y-axis direction. The X-axis direction may be referred to as the row direction, and the Y-axis direction as the column direction, in the following description.

Referring to FIG. 3, each TFT 60 includes: a gate electrode 61 connected to one of the gate lines 81; a source electrode 62 connected to one of the source line 82; a drain electrode 63 connected to one of the pixel electrodes 70 via a drain line 84 (detailed later); and a channel section 64 connected to the source electrode 62 and the drain electrode 63. When the TFT 60 is driven on the basis of a scan signal transmitted via the gate line 81, the electrical potential related to an image signal supplied to the source line 82 is fed to the drain electrode 63 via the channel section 64, charging the pixel electrode 70 up to the electrical potential related to the image signal.

Still referring to FIG. 3, each pixel electrode 70 is located in a region surrounded by a pair of one of the gate lines 81 and one of the source lines 82. The pixel electrode 70 is shaped generally like a vertically elongated parallelogram. The pixel electrode 70 has a short side parallel to the gate line 81 which extends linearly in the X-axis direction. In addition, every other pixel electrode 70 is turned upside down when traced along the Y axis, so that the linear long sides of the pixel electrodes 70, tilted against the short sides thereof, extend as a whole in a zigzag manner generally along the source lines 82. Each pixel electrode 70 has a plurality of slits 70A (four slits in present Embodiment 1) opened and extending along the long side thereof. The inner face of the display area AA on the array substrate 30 has thereon a common electrode 75 overlapping the pixel electrodes 70 (see FIG. 2). When electrical potential differences develop between the overlapping pixel electrodes 70 and common electrode 75, the liquid crystal layer LC is subjected to a fringe electric field (oblique electric field) that has a component normal to the face of the array substrate 30 near the slits 70A as well as a component parallel to the face of the array substrate 30.

Still referring to FIG. 3, there is provided a capacitor line 83 between every pair of gate lines 81 that flanks the pixel electrode 70 with respect to the Y-axis direction, in such a manner that the capacitor line 83 extends parallel to the gate line 81 and crosses a plurality of pixel electrodes 70 and a plurality of source lines 82. The capacitor line 83 is provided in a different layer from the pixel electrode 70 and the source line 82 and partially overlaps the pixel electrode 70, thereby providing an electrostatic capacitance. The capacitor line 83 enables the pixel electrode 70 to be maintained for a predetermined period of time at the electrical potential to which the pixel electrode 70 is charged upon the driving of the TFT 60. The capacitor line 83 is provided in the same layer as the gate line 81. The capacitor line 83 is preferably, but not necessarily, at the same electrical potential as the common electrode 75.

A description is now given of various films stacked on the inner face of the array substrate 30. The array substrate 30, as shown in FIG. 2, is provided with a first metal film (gate metal film) 32A, a gate insulating film 33, a semiconductor film 34, a second metal film (source metal film) 32B, a first interlayer insulating film 35A, a planarizing film 36, a first transparent electrode film 37A, a second interlayer insulating film 35B, a second transparent electrode film, and an alignment film stacked in this order when viewed from the transparent substrate 31. FIG. 2 illustrates a cross-sectional structure between pixel sections in the display area AA of the liquid crystal panel 10. The second transparent electrode film is not shown in FIG. 2. The alignment film is not shown in, for example, FIG. 2. These films may be formed by photolithography or other publicly known film-forming technology.

The first metal film 32A is either a stack of films of different metal materials or a single-layered film of a single metal material and constitutes, for example, at least a part of the gate electrodes 61, the gate lines 81, the capacitor lines 83, and auxiliary lines of the TFTs 60. The gate insulating film 33 is composed of an inorganic insulating material (inorganic material) such as SiNₓ or SiO₂. The semiconductor film 34 is composed (primarily) of a thin film of, for example, a semiconductor oxide and constitutes, for example, at least a part of the channel sections 64 of the TFTs 60. The second metal film 32B is either a stack of films or a single-layered film similarly to the first metal film 32A and constitutes at least a part of the source electrodes 62, the drain electrodes 63, the source lines 82, and the drain lines 84 of the TFTs 60. The first interlayer insulating film 35A is composed of an inorganic insulating material similarly to the gate insulating film 33. The planarizing film 36 is composed of an organic insulating material (organic material) such as PMMA (acrylic resin) and has a larger thickness than the other insulating films 33, 35A, and 35B composed of an inorganic resin material. The planarizing film 36 planarizes the inner surface of the array substrate 30. The first transparent electrode film 37A is composed of a transparent electrode material such as ITO and constitutes at least a part of the common electrode 75. The second interlayer insulating film 35B is composed of an inorganic insulating material similarly to, for example, the gate insulating film 33. The second transparent electrode film is composed of a transparent electrode material similarly to the first transparent electrode film 37A and constitutes at least a part of the pixel electrodes 70. The alignment film is composed of, for example, a polyimide and disposed on top of all the other films on the inner face of the array substrate 30 (interfacing with the liquid crystal layer LC). The alignment film is in contact with the liquid crystal layer LC enclosed between the substrates 20 and 30, to align the liquid crystal molecules in the liquid crystal layer LC in a prescribed direction. Rubbing and other alignment processes may be performed where necessary.

As shown in FIG. 3, the first interlayer insulating film 35A, the planarizing film 36, and the second interlayer insulating film 35B have contact holes CH opened therethrough. The contact holes CH are provided to connect the pixel electrodes 70 composed of the second transparent electrode film to the drain lines 84 composed of the second metal film 32B. The contact holes CH are disposed in locations over both the pixel electrodes 70 and the drain lines 84 in a plan view. The first interlayer insulating film 35A, the planarizing film 36, and the second interlayer insulating film 35B are provided at least across the entire display area AA, except for the contact holes CH.

A description will be given next of the CF substrate 20 with reference to FIGS. 2 to 4. On the inner face of the display area AA of the CF substrate 20 (i.e., on the interface with the liquid crystal layer LC or on the face of the CF substrate 20 opposing the array substrate 30) are there provided a light-blocking layer 40, a color filter 22, and an overcoat layer 23 in this order when viewed from the transparent substrate 21 as shown in FIG. 2. Spacers 50 are provided so as to project from the surface of the overcoat layer 23 toward the liquid crystal layer LC. The overcoat layer 23 is provided at least substantially across the entire display area AA, to protect the color filter 22. The alignment film is formed on top of all these structural elements in contact with the liquid crystal layer LC, but not shown in, for example, FIG. 2.

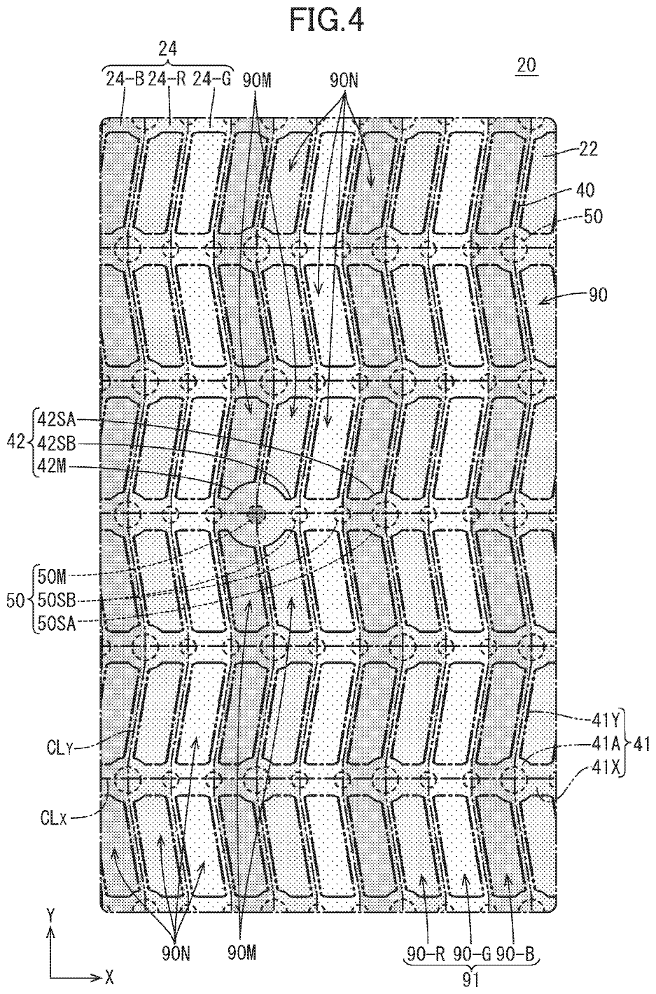

Referring to FIG. 2, the color filter 22 is composed of a plurality of coloring sections 24. Referring to FIG. 4, the coloring sections 24 are arranged in a matrix with respect to the X-axis direction (row direction) and the Y-axis direction (column direction) in a plan view of the liquid crystal panel 10. Each coloring section 24 is provided in a location opposite one of the pixel electrodes 70 disposed on the array substrate 30 and is shaped generally like a vertically elongated parallelogram similarly to the pixel electrode 70. A pair of these oppositely located coloring section 24 and pixel electrode 70 constitutes a pixel section 90. Each coloring section 24 contains pigment in accordance with the color that the coloring section 24 is to give off. Accordingly, the coloring section 24 selectively transmits light of that color (light of a specific color) owing to the pigment absorbing the light of the color that the coloring section 24 is not to give off. Referring to FIG. 2, the color filter 22 in accordance with the present embodiment includes the three-colored coloring sections 24, namely, red coloring sections 24-R that give off the red color, green coloring sections 24-G that give off the green color, and blue coloring sections 24-B that give off the blue color. Each pixel 91 includes a set of a red pixel section 90-R, a green pixel section 90-G, and a blue pixel section 90-B that are arranged adjacent to each other along the X-axis direction. Referring to FIG. 4, the liquid crystal panel 10 in accordance with the present embodiment is capable of producing a color display with prescribed gray levels owing to the pixels 91 being arranged in a matrix in the display area AA.

Referring to FIG. 4, the pixel sections 90 in accordance with the present embodiment are shaped to form congruent parallelograms in a plan view. In other words, all the coloring sections 24 in the display area AA have the same area ratio. The pixels 91 are arranged such that those pixel sections 90 that are adjacent in the X-axis direction give off different colors. Specifically, the red pixel section 90-R, the green pixel section 90-G, and the blue pixel section 90-B are arranged repeatedly in a prescribed order in the X-axis direction. Meanwhile, the pixels 91 are arranged such that those pixel sections 90 that are adjacent in the Y-axis direction give off the same color. Specifically, in the Y-axis direction, the red pixel sections 90-R, the green pixel sections 90-G, or the blue pixel sections 90-B are arranged contiguous to each other substantially across the entire length of the display area AA. Every other pixel section 90 is turned upside down when traced along the Y axis similarly to the pixel electrodes 70. The pixel sections 90 extend in a zigzag manner along the source lines (signal lines) 82 on the array substrate 30.

Among the three-colored, red pixel section 90-R, green pixel section 90-G, and blue pixel section 90-B included in each pixel 91, the red pixel section 90-R and the blue pixel section 90-B selectively transmit red and blue light respectively that have lower relative luminosities than green light and for this reason appear darker than the green pixel section 90-G at the same or close gray levels. Conversely, the green pixel section 90-G selectively transmits green light that has a higher relative luminosity than red and blue light and for this reason appears brighter than the red pixel section 90-R and the blue pixel section 90-B at the same or close gray levels. For instance, two liquid crystal panels having the equal average pixel section aperture ratio of 60% can have different panel transmittances and different screen luminances if the green pixel section 90-G has an aperture ratio of 66%, and the red pixel section 90-R and the blue pixel section 90-B has an aperture ratio of 57% in one of the liquid crystal panels, and one of the red pixel section 90-R and the blue pixel section 90-B has an aperture ratio of 66%, and the other one of the red pixel section 90-R and the blue pixel section 90-B as well as the green pixel section 90-G has an aperture ratio of 57% in the other liquid crystal panel. The former liquid crystal panel has a higher panel transmittance and a higher screen luminance than the latter liquid crystal panel. Thus, to improve the screen luminance of the liquid crystal panel 10 by changing the aperture ratios of the pixel sections 90, the screen luminance can be increased more effectively by increasing the aperture ratio of the green pixel section 90-G than by increasing the aperture ratios of the red pixel section 90-R and the blue pixel section 90-B. In other words, the green pixel section 90-G contributes more to the panel transmittance of the liquid crystal panel 10 than the red pixel section 90-R and the blue pixel section 90-B.

As shown, for example, in FIG. 4, the light-blocking layer 40 is formed in a prescribed pattern in a plan view. The light-blocking layer 40 in the display area AA includes, for example, inter-pixel-section light-blocking sections 41 and spacer light-blocking sections.

Referring to FIG. 4, the inter-pixel-section light-blocking sections 41 as a whole form a lattice in the display area AA generally with respect to the X-axis direction and the Y-axis direction, so as to provide partitions between adjacent pixel sections 90. The inter-pixel-section light-blocking sections 41, placed at the boundaries between those pixel sections 90 that are adjacent in the X-axis direction and the Y-axis direction, reduce chances of light going back and forth between those pixel sections 90 that are adjacent in the X-axis direction and the Y-axis direction, thereby ensuring the independence of display gray levels for each pixel section 90. As described here, the inter-pixel-section light-blocking sections 41 serve to reinforce the optical boundary of each pixel section 90 light transmission through which is turned on/off by driving the associated one of the pixel electrodes 70, prevent color mixing, and enhance the contrast of display images. As indicated by dash-double-dot lines in FIG. 3, which is an enlarged view, some of the inter-pixel-section light-blocking sections 41 are extended in the X-axis direction. These extensions are referred to as X-axis-direction extensions 41X and run along the gate lines 81. Meanwhile, some of the inter-pixel-section light-blocking sections 41 are extended substantially in the Y-axis direction. These extensions are referred to as Y-axis-direction extensions 41Y and run in a zigzag manner along the source lines 82. On the CF substrate 20 given as an example in the present embodiment, the X-axis-direction extensions 41X are wider than the Y-axis-direction extensions 41Y and not only overlap the gate lines 81, but also overlap the TFTs 60, the capacitor lines 83 running parallel to the gate lines 81, and other structural elements on the array substrate 30. The intersecting portions of the X-axis-direction extensions 41X and the Y-axis-direction extensions 41Y may be referred to as intersecting portions 41A in the following description.

The spacer light-blocking sections are provided in the display area AA to shield the spacers 50 and regions surrounding the spacers 50 from light. To shield these surrounding regions of the spacers 50 from light, the spacer light-blocking sections preferably cover similar regions larger than the spacers 50, in other words, those regions extended from the peripheries of the spacers 50 by a predetermined width, in a plan view. The surface of the array substrate 30, when scraped by the spacers 50, can produce shavings, which may in turn cause bright dot defects. The presence of the spacers 50 can disturb the alignment of the liquid crystal molecules in the liquid crystal layer LC, which may in turn cause an improper display. The spacer light-blocking sections render these shavings and alignment disturbance less visually recognizable on the image display screen of the liquid crystal panel 10. By rendering improper displays that can occur above the spacers 50 and the regions surrounding the spacers 50 less visually recognizable as described here, the spacer light-blocking sections suppress degradation of the image display quality of the liquid crystal panel 10. The spacers 50 are located to overlap the inter-pixel-section light-blocking sections 41 in the present embodiment as will be described later in detail. This arrangement enables the inter-pixel-section light-blocking sections 41 to contain at least parts of the spacer light-blocking sections, thereby reducing the footprint of the light-blocking layer 40 in the entire liquid crystal panel 10. Referring to FIGS. 3 and 4, the parts of the spacer light-blocking sections that are not contained in the inter-pixel-section light-blocking sections 41 are formed as extended light-blocking sections 42 that are inner extensions of the pixel sections 90 and that are adjacent to the inter-pixel-section light-blocking sections 41. The extended light-blocking sections 42 will be described later in detail.

In the present embodiment, the spacers 50 include main spacers (an example of first spacers) 50M and two types of subspacers, namely, larger subspacers (an example of second spacers) 50SA and smaller subspacers (an example of third spacers) 50SB. The spacers 50 may be made of, for example, a transparent resin material. A description will be given next of these spacers 50 with reference to FIGS. 2 to 4.

As shown in FIG. 2, the main spacers 50M have a projection length P_{M} approximately equal to the cell gap G. This structure allows the projection end faces of the main spacers 50M to come into contact with the inner surface of the array substrate 30, thereby bringing the main spacers 50M into contact with both substrates. The structure hence maintains a prescribed distance (cell gap G) between the substrates 20 and 30. More specifically, the main spacers 50M can be slightly compressed under the load exerted thereon when the array substrate 30 and the CF substrate 20 are attached. The projection length P_{M} should be specified taking the compression into account in providing the main spacers 50M.

Meanwhile, the subspacers 50SA and 50SB are both formed to have a projection length P_{S} smaller than the projection length P_{M} (i.e., the cell gap G) of the main spacers 50M and are disposed opposite each other, leaving clearance between the subspacers 50SA and 50SB and the inner surface of the array substrate 30. The subspacers 50SA and 50SB primarily serve to receive an external force pressing the face of the liquid crystal panel 10 in order to protect the internal structure of the liquid crystal panel 10. Under an external force pressing the array substrate 30 or the CF substrate 20, the substrates 20 and 30 can deform by as much as the clearance formed between the subspacers 50SA and 50SB on the CF substrate 20 and the inner surface of the array substrate 30. The substrates 20 and 30 however do not deform more than that because the projection end faces of the subspacers 50SA and 50SB projecting from the CF substrate 20 come into contact with the inner surface of the array substrate 30. Neither the subspacers 50SA nor 50SB are in contact with the array substrate 30 in a normal state. The presence of the subspacers 50SA and 50SB hence restrains excessive reduction of the volume of the liquid crystal layer LC, and the structure of the subspacers 50SA and 50SB prevents projection ends thereof from damaging the inner surface of the array substrate 30.

As shown in FIGS. 2 and 3, the present embodiment gives an example of the main spacers 50M and the subspacers 50SA and 50SB where the main spacers 50M and the subspacers 50SA and 50SB are each shaped like a truncated cone, with a generally circular cross-section, that decreases in diameter from the CF substrate 20 toward the array substrate 30. The main spacers 50M and the subspacers 50SA and 50SB have a footprint that is preferably determined in view of the balance between the functions of the spacers 50 and the light-blocking area required by the subspacers 50SA and 50SB. In the following description, the “footprint” of a spacer refers to the area occupied by the bottom of the spacer. The liquid crystal panel 10 has surface pressure resistance that varies depending on the subspacer areal concentration, that is, the ratio of the total footprint of the subspacers to the total area of the face of the liquid crystal panel. The subspacers 50SA and 50SB are accordingly provided with a total footprint that accounts for at least a prescribed proportion of the total area of the face of the liquid crystal panel 10, in order to secure surface pressure resistance of greater than or equal to a predetermined level. The subspacer areal concentration may vary depending on the operating environment of the liquid crystal panel 10 and, specifically, is preferably greater than or equal to approximately 5% in view of the reduction of the aperture ratio of pixel sections caused by the subspacer light-blocking sections that will be described later in detail.

The main spacers 50M are in contact with the inner surface of the array substrate 30 when the main spacers 50M are in a natural state where no external force is being exerted thereon, in other words, in a normal state. The regions surrounding the main spacers 50M are therefore relatively prone to bright dot defects and alignment disturbance. The main spacer light-blocking sections, which are those spacer light-blocking sections that shield the regions surrounding the main spacers 50M from light, need to shield large areas. The main spacers 50M preferably have as small a footprint as possible and are provided in as small a number as possible, so long as the cell gap G can be maintained, in order to reduce the footprint of the light-blocking layer 40 in the entire liquid crystal panel 10 and hence restrain decrease in luminance. The typical number of the main spacers is approximately 1/100 to 1/10 the total number of pixel sections.

On the other hand, the regions surrounding the subspacers 50SA and 50SB are less prone to improper display than the regions surrounding the main spacers 50M since the subspacers 50SA and 50SB are disposed opposite each other with clearance being left between the subspacers 50SA and 50SB and the inner surface of the array substrate 30 in a normal state. Thus, the subspacer light-blocking sections, which are those spacer light-blocking sections that shield the regions surrounding the subspacers 50SA and 50SB from light, may be relatively small. At least a prescribed number of subspacers (distribution density) should be provided to give at least a prescribed footprint, in order to secure sufficient surface pressure resistance in case of an external force being exerted on a very limited area of the liquid crystal panel 10. The typical number of the subspacers is approximately ⅕ to 1/1 the total number of pixel sections. In addition, because the subspacer light-blocking sections are provided so as to cover the extensions of a predetermined width of the periphery of the subspacers in a plan view. Therefore, when the subspacers include the differently-sized, larger subspacers 50SA and smaller subspacers 50SB as in the present embodiment, the smaller subspacer light-blocking sections for the smaller subspacers 50SB may be made far smaller than the larger subspacer light-blocking sections for the larger subspacers 50SA. The number of the smaller subspacers 50SB is preferably specified to be larger than the number of the larger subspacers 50SA, in order to reduce the footprint of the light-blocking layer 40 and hence restrain decrease in luminance in the liquid crystal panel 10.

Referring to FIGS. 3 and 4, the spacers 50 are preferably disposed in locations over the inter-pixel-section light-blocking sections 41. This structure enables the inter-pixel-section light-blocking sections 41 to contain all or parts of the spacer light-blocking sections, which in turn enables the distribution of the numerous spacers 50 with a predetermined concentration across the display panel while reducing the footprint of the light-blocking layer 40 to a minimum. The present embodiment gives an example of the main spacers 50M and the subspacers 50SA and 50SB where the main spacers 50M and the subspacers 50SA and 50SB are all disposed in locations over the inter-pixel-section light-blocking sections 41. These spacers 50 are preferably disposed at the intersecting portions 41A of the latticed inter-pixel-section light-blocking sections 41 because this structure increases the area of the spacer light-blocking sections contained in the inter-pixel-section light-blocking sections 41 and reduces the size of the extended light-blocking sections 42 which are inward extensions of the pixel sections 90. These effects are particularly evident with the main spacers 50M which require large spacer light-blocking sections and the larger subspacers 50SA which require relatively large spacer light-blocking sections. The present embodiment gives an example where all the main spacers 50M and the subspacers 50SA and 50SB are arranged such that the centers of the main spacers 50M and the subspacers 50SA and 50SB overlap the centers of the intersecting portions 41A of the inter-pixel-section light-blocking sections 41, in other words, the intersections of the centerlines CL_{X} of the X-axis-direction extensions 41X and the centerlines CL_{Y} of the Y-axis-direction extensions 41Y as shown in FIG. 4. The in-plane layout of the main spacers 50M and the subspacers 50SA and 50SB across the entire liquid crystal panel 10 will be described later in detail.

A description will be given next of the extended light-blocking sections 42. Referring to, for example, FIG. 3, the extended light-blocking sections 42, in the present embodiment, are inward extensions of the four pixel sections 90 which are contiguous to the intersecting portions 41A and separated by the intersecting portions 41A, the intersecting portions 41A being those parts of the inter-pixel-section light-blocking sections 41 where the spacers 50M, 50SA, and 50SB are located. The shavings produced by the spacers 50M, 50SA, and 50SB are likely to concentrate in the regions near and surrounding the intersecting portions 41A where the spacers 50M, 50SA, and 50SB are located. The additional provision of the extended light-blocking sections 42 in these regions efficiently renders the bright dot defects caused by the shavings less visually recognizable. In the present embodiment, since the spacers 50M, 50SA, and 50SB are located in the intersecting portions 41A, those regions of the spacer light-blocking sections for the spacers 50M, 50SA, and 50SB that are contained in the inter-pixel-section light-blocking sections 41 are increased. Thus, in comparison with a structure where spacers are disposed in locations outside the intersecting portions 41A of the inter-pixel-section light-blocking sections 41, the current structure can reduce the area of the individual extended light-blocking sections 42 and alleviate decreases in the aperture ratio of the pixel sections 90 facing the spacers 50 while preserving the same level of light shielding. Furthermore, in the present embodiment, since the spacers 50M, 50SA, and 50SB, shaped like truncated cones, have centers thereof overlapping the centers of the intersecting portions 41A of the inter-pixel-section light-blocking sections 41, those four extended light-blocking sections 42 that are contiguous to the same one of the intersecting portions 41A have an equal area. All the spacers 50M, 50SA, and 50SB, in the present embodiment, have a circular cross-sectional shape. The spacer light-blocking sections for the spacers 50M, 50SA, and 50SB are preferably circular like a concentric circle larger than the spacers 50M, 50SA, and 50SB. Each extended light-blocking section 42 is shaped like an arc with the side farthest from the center of the intersecting portion 41A being a part of the periphery of the circle that have the same center as does the intersecting portion 41A.

The extended light-blocking sections 42 contain the regions that are not contained in the inter-pixel-section light-blocking sections 41 among the spacer light-blocking sections for the spacers 50M, 50SA, and 50SB. As described earlier, the main spacer light-blocking sections for shielding the regions surrounding the main spacers 50M from light need to be large, whereas the subspacer light-blocking sections for the larger subspacers 50SA may be relatively large (of a medium size), and the subspacer light-blocking sections for the smaller subspacers 50SB may be small. Therefore, as shown in FIGS. 3 and 4, large main-spacer-use extended light-blocking sections 42M are provided in the pixel sections 90 facing the main spacers 50M, in other words, in main-spacer-adjoining pixel sections 90M adjacent to the inter-pixel-section light-blocking sections 41 in locations where the main spacers 50M are provided. There are provided medium-sized, larger subspacer-use extended light-blocking sections 42SA in the pixel sections 90 facing the larger subspacers 50SA and small-sized, smaller subspacer-use extended light-blocking sections 42SB in the pixel sections 90 facing the smaller subspacers 50SB. In the following description, the pixel sections 90 not facing the main spacers 50M may be referred to as main-spacer-non-adjoining pixel sections 90N.

The extended light-blocking sections 42 are provided, where necessary, so as to further contain dummy regions for maintaining image display quality. A large difference in aperture ratio between the main-spacer-adjoining pixel sections 90M where the large, main-spacer-use extended light-blocking sections 42M are provided and the main-spacer-non-adjoining pixel sections 90N where no main-spacer-use extended light-blocking sections 42M are provided will cause significant local decreases in luminance, which may in turn produce a visually recognizable pattern on the display screen. This degradation of image display quality may be effectively suppressed by providing the subspacer-use extended light-blocking sections 42SA and 42SB having such large areas as to contain dummy regions in addition to the regions needed to shield the regions around the subspacers 50SA and 50SB from light because this structure reduces the difference in aperture ratio between the main-spacer-adjoining pixel sections 90M and the main-spacer-non-adjoining pixel sections 90N, thereby alleviating local irregular luminance and color and rendering irregularities less visually recognizable on the screen. Meanwhile, when the subspacer-use extended light-blocking sections 42SA and 42SB are specified to have such a large area as to contain dummy regions in this manner, the liquid crystal panel 10 will have such a low total aperture ratio that luminance falls across the display screen. Accordingly, in the present embodiment, the in-plane layout of the main spacers 50M and the subspacers 50SA and 50SB is optimized across the liquid crystal panel 10 in order to keep the aperture ratio difference between the main-spacer-adjoining pixel sections 90M and the main-spacer-non-adjoining pixel sections 90N equal to or below a predetermined level while suppressing decrease in aperture ratio by reducing dummy regions contained in the subspacer-use extended light-blocking sections 42SA and 42SB to a minimum.

A description will be given next of the in-plane layout of the main spacers 50M and the subspacers 50SA and 50SB across the liquid crystal panel 10. The present embodiment gives an example where there is provided a spacer 50 in each intersecting portion 41A of the inter-pixel-section light-blocking sections 41 arranged to form a lattice in the display area AA as shown in FIG. 4. Because the main spacers 50M account for a very low percentage of the spacers 50, the ratio of the total number of the subspacers 50SA and 50SB to the total number of the pixel sections 90 is approximately equal to 1:1 in the present embodiment. Additionally, the ratio of the number of the larger subspacers 50SA and the number of the smaller subspacers 50SB is approximately 1:2, and these subspacers 50SA and 50SB are arranged in the X- and Y-axis directions in a prescribed order. Specifically, in those intersecting portions 41A that are adjacent in the X-axis direction, are there basically arranged larger subspacer 50SA and smaller subspacer 50SB in the order of a larger subspacer 50SA, a smaller subspacer 50SB, and another smaller subspacer 50SB in a repeated manner. The pixel sections 90 (the red pixel sections 90-R, the green pixel sections 90-G, and the blue pixel sections 90-B) are arranged in a prescribed order repeatedly along the X-axis direction as described earlier. The larger subspacers 50SA are provided in the intersecting portions 41A located between the blue pixel sections 90-B and the red pixel sections 90-R. In contrast, those intersecting portions 41A that are adjacent in the Y-axis direction are basically arranged such that the larger subspacers 50SA or the smaller subspacers 50SB are contiguous approximately across the entire length of the display area AA. As described earlier, the pixel sections 90 are arranged so that the red pixel sections 90-R, the green pixel sections 90-G, or the blue pixel sections 90-B are individually contiguous in the Y-axis direction. Thus, in the present embodiment, as shown in FIG. 4, all the larger subspacers 50SA are disposed in the intersecting portions 41A located between the columns formed by the blue pixel sections 90-B and the columns formed by the red pixel sections 90-R, whereas the smaller subspacers 50SB are disposed in the intersecting portions 41A located between the columns formed by the green pixel sections 90-G and the columns formed by the red pixel sections 90-R or the blue pixel sections 90-B.

The present embodiment gives an example where the main spacers 50M are disposed in locations where basically, some of the larger subspacers 50SA, among the subspacers 50SA and 50SB arranged in the prescribed order, are replaced. Similarly to the larger subspacers 50SA, the main spacers 50M are accordingly disposed in the intersecting portions 41A located between the columns formed by the blue pixel sections 90-B and the columns formed by the red pixel sections 90-R. In other words, only the smaller subspacers 50SB, neither the main spacers 50M nor the larger subspacers 50SA, are disposed in the intersecting portions 41A adjacent to the green pixel sections 90-G.

In this layout, there are provided four smaller subspacers 50SB, either four larger subspacers 50SA or three larger subspacers 50SA, and one main spacer 50M in each inter-pixel-section light-blocking section 41 adjacent to the pixel 91 formed by a set of one red pixel section 90-R, one green pixel section 90-G, and one blue pixel section 90-B arranged next to each other along the X-axis direction. In other words, for each pixel 91, there is provided a total of four main spacers 50M and larger subspacers 50SA in the inter-pixel-section light-blocking section 41 adjacent to the pixel section 90 contained in the pixel 91.

As described earlier, in the pixel section 90 adjacent to the intersecting portion 41A where the spacer 50 is disposed, those extended light-blocking sections 42 that are of a size in accordance with the type of the disposed spacer 50 are disposed contiguous to the intersecting portion 41A. In the structure in accordance with the present embodiment where the main spacers 50M and the subspacers 50SA and 50SB are disposed as described above, the large, main-spacer-use extended light-blocking sections 42M are provided in the blue pixel sections 90-B and the red pixel sections 90-R which form the main-spacer-adjoining pixel sections 90M. The medium-sized, larger subspacer-use extended light-blocking sections 42SA are also provided in the blue pixel sections 90-B and the red pixel sections 90-R. In contrast, only the small-sized, smaller subspacer-use extended light-blocking sections 42SB are formed in the green pixel sections 90-G.

### Verification Experiment 1

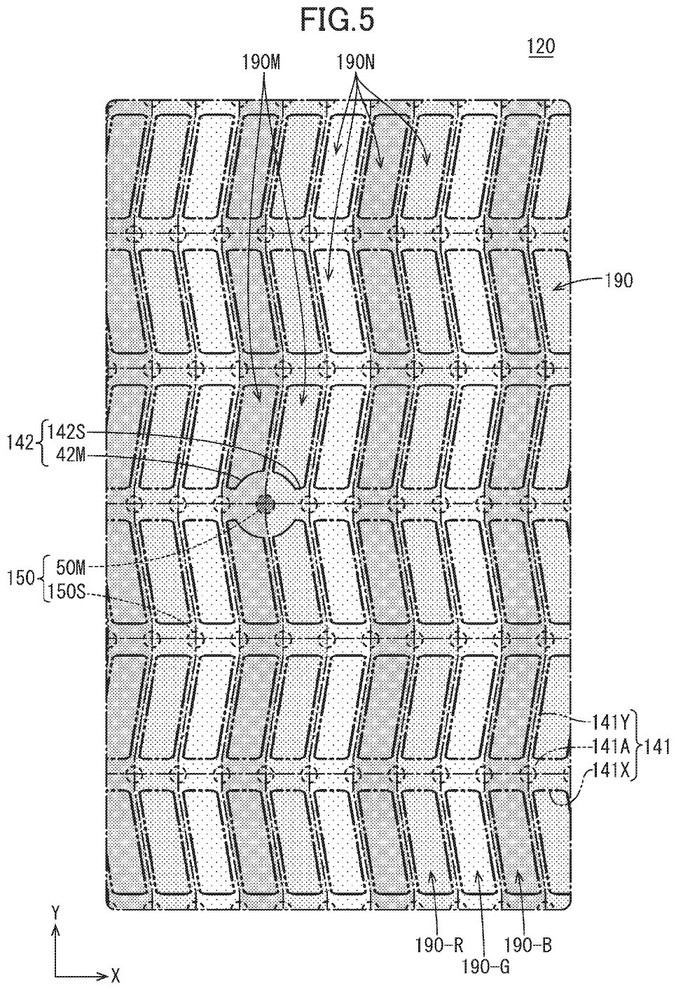

Verification Experiment 1 was conducted as follows to investigate the effects, on the panel transmittance of the liquid crystal panel 10, of the provision described above of the main spacers 50M, the larger subspacers 50SA, and the smaller subspacers 50SB as the spacers 50. In present Verification Experiment 1, the liquid crystal panel 10 including the CF substrate 20 in accordance with present Embodiment 1 described so far (see, for example, FIG. 4) was used as Example 1. A liquid crystal panel including a CF substrate 120 (see FIG. 5) that had a different structure from the CF substrate 20 was used as Comparative Example 1. The following will describe the liquid crystal panel in accordance with Comparative Example 1, but may not elaborate on members and structures commonly included in both Embodiment 1 and Comparative Example 1 and where appropriate, use the same reference numerals for these members because the liquid crystal panel has the same basic configuration as the liquid crystal panel 10 of Embodiment 1.

Referring to FIG. 5, the CF substrate 120 in accordance with Comparative Example 1 included spacers 150 that in turn included two types of spacers: main spacers 50M and subspacers 150S. Extended light-blocking sections 142 for shielding the main spacers 50M and the subspacers 150S from light included two types of extended light-blocking sections, namely, main-spacer-use extended light-blocking sections 42M and subspacer-use extended light-blocking sections 142S. The main spacers 50M and the main-spacer-use extended light-blocking sections 42M in Comparative Example 1 had the same shape, footprint, and layout as those in Example 1. Accordingly, as in Example 1, there was provided a very small number of main spacers 50M in the liquid crystal panel in accordance with Comparative Example 1, and all the main spacers 50M were disposed in intersecting portions 141A located between red pixel sections 190-R and blue pixel sections 190-B.

Each subspacer 150S, similarly to the subspacers 50SA and 50SB in accordance with Embodiment 1, was shaped like a truncated cone that decreased in diameter from the bottom toward the projection end. As shown in FIG. 5, the subspacers 150S were arranged such that the centers of the subspacers 150S overlapped the centers of the intersecting portions 141A of latticed, inter-pixel-section light-blocking sections 141. Similarly to the spacers 50 in accordance with Example 1, there was provided one spacer 150 in accordance with Comparative Example 1 in each intersecting portion 141A where X-axis-direction extensions 141X intersected Y-axis-direction extensions 141Y in the inter-pixel-section light-blocking sections 141. In other words, in Comparative Example 1, the ratio of the number of the subspacers 150S to the total number of pixel sections 190 was approximately 1/1, and the subspacers 150S were disposed in all locations where the larger subspacers 50SA or the smaller subspacers 50SB were provided in the liquid crystal panel 10 in accordance with Embodiment 1 (in all the intersecting portions 141A except for those intersecting portions 141A where the main spacers 50M were provided).

All main-spacer-adjoining pixel sections 190M facing the main spacers 50M in Comparative Example 1 were the red pixel sections 190-R or the blue pixel sections 190-B. All green pixel sections 190-G in Comparative Example 1 were main-spacer-non-adjoining pixel sections 190N not facing the inter-pixel-section light-blocking sections 41 in locations where the main spacers 50M were provided.

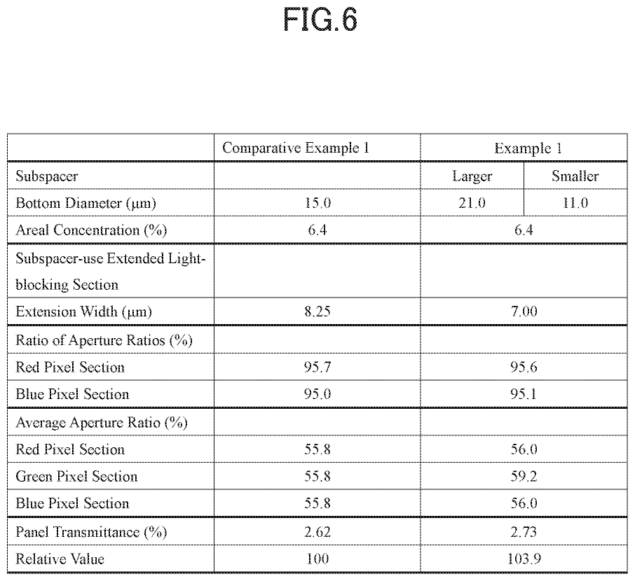

In both the liquid crystal panels of Example 1 and Comparative Example 1, the spacers 50 and 150 were adjusted, for example, in dimensions, shape, and numbers as shown in a table in FIG. 6, in such a manner that the subspacer areal concentration, which is a ratio of the total footprint of the subspacers to the entire area of the face of the liquid crystal panel, was equal to 6.4%. This adjustment ensured predetermined surface pressure resistance across the liquid crystal panels. Specifically, as shown in the table in FIG. 6, the subspacers 150S in accordance with Comparative Example 1 were formed to have a bottom diameter of 15.0 μm, whereas the larger subspacers 50SA and the smaller subspacers 50SB in accordance with Example 1 were formed to have a bottom diameter of 21.0 μm and 11.0 μm respectively.

The liquid crystal panels further included subspacer-use extended light-blocking sections such that the ratio of the aperture ratio of the main-spacer-adjoining pixel sections to the aperture ratio of the main-spacer-non-adjoining pixel sections, which may be referred to as the ratio of aperture ratios, was greater than or equal to 95%. Specifically, in Comparative Example 1, all the subspacer-use extended light-blocking sections 142S were provided so as to have an extension width of 8.25 μm from the peripheries of the subspacers 150S as shown in the table in FIG. 6, so that the ratio of the aperture ratio of the main-spacer-adjoining pixel sections 190M to the aperture ratio of the main-spacer-non-adjoining pixel sections 190N was greater than or equal to 95%. In contrast, in Example 1, all the larger subspacer-use extended light-blocking sections 42SA and the smaller subspacer-use extended light-blocking sections 42SB are disposed so as to have an extension width of 7.00 μm from the peripheries of either the larger subspacers 50SA or the smaller subspacers 50SB. This structure of Example 1 enables the ratio of the aperture ratio of the main-spacer-adjoining pixel sections 90M to the aperture ratio of the main-spacer-non-adjoining pixel sections 90N to be greater than or equal to 95.1%. The ratio of aperture ratios was calculated only for the red pixel sections and blue pixel sections because there were provided no green pixel sections 90-G and 190-G that served as the main-spacer-adjoining pixel sections 90M and 190M.

An average aperture ratio was calculated of the red and blue pixel sections 90 and 190 of these liquid crystal panels in accordance with Example 1 and Comparative Example 1. In addition, a panel transmittance was measured on the liquid crystal panels. Results are shown in the table in FIG. 6. Liquid crystal display devices were prepared by mounting a backlight unit to the liquid crystal panels. The luminance of a display area AA was measured on these liquid crystal display devices while the liquid crystal display devices were producing a white display. The panel transmittance, expressed in percentage, was obtained by dividing the measured luminance by the luminance of the backlight unit alone. The table in FIG. 6 additionally lists the panel transmittance obtained in Example 1 in a relative value by taking the panel transmittance obtained in Comparative Example 1 as being equal to 100.

The table in FIG. 6 shows that the average aperture ratios of the red pixel sections 90-R, the green pixel sections 90-G, and the blue pixel sections 90-B in the liquid crystal panel 10 of Example 1 were not high at all when compared with the average aperture ratios of the red pixel sections 190-R, the green pixel sections 190-G, and the blue pixel sections 190-B in the liquid crystal panel of Comparative Example 1. This is presumably because the two types of subspacers, that is, the larger subspacers 50SA and the smaller subspacers 50SB, were designed to have such sizes (footprints) as to strike a suitable balance and arranged to face the main-spacer-adjoining pixel sections 90M and the main-spacer-non-adjoining pixel sections 90N in a well-balanced manner across the entire liquid crystal panel 10. This design achieved the target ratio of aperture ratios of greater than or equal to 95% and still reduced the required extension width to 7.00 μm in the subspacer-use extended light-blocking sections 42SA and 42SB in Example 1 over the extension width of 8.25 μm in the subspacer-use extended light-blocking sections 142S in Comparative Example 1. The design could hence suppress the dummy regions in the subspacer-use extended light-blocking sections, which in turn likely reduced the footprint of the light-blocking layer 40 across the entire liquid crystal panel 10 and increased the average aperture ratio of the color pixel sections 90-R, 90-G, and 90-B.

The table in FIG. 6 further shows that the average aperture ratios calculated of the red pixel sections 190-R, the green pixel sections 190-G, and the blue pixel sections 190-B were approximately equal in the liquid crystal panel of Comparative Example 1. This was because all the intersecting portions 141A adjacent to the pixel sections 190 were provided basically with the same subspacers 150S and the number of the main spacers 50M selectively disposed in the intersecting portions 41A adjacent to the red pixel sections 190-R and the blue pixel sections 190-B was far smaller than the total number of the pixel sections. In contrast, in Example 1, the average aperture ratio of the green pixel sections 90-G was higher than the average aperture ratio of the red pixel sections 90-R and the blue pixel sections 90-B. This was because the larger subspacers 50SA, which was one of the two types of subspacers with different footprints (subspacers 50SA and 50SB) that had a larger footprint and required larger spacer light-blocking sections, were not disposed in the intersecting portions 41A adjacent to the green pixel sections 90-G. The reasons were that the main-spacer-use extended light-blocking sections 42M and the larger subspacer-use extended light-blocking sections 42SA, which were large, were provided in the red pixel sections 90-R and the blue pixel sections 90-B and that only the smaller subspacer-use extended light-blocking sections 42SB, which were all small, were provided in the extended light-blocking sections 42 in the green pixel sections 90-G. As described earlier, the green pixel sections 90-G contributed more to the panel transmittance than did the red pixel sections 90-R and the blue pixel sections 90-B. Thus, in the liquid crystal panel 10 of Example 1 where the green pixel sections 90-G had an increased aperture ratio, the panel transmittance was efficiently improved by approximately 3.9% over the liquid crystal panel of Comparative Example 1.

As described so far, the liquid crystal panel in accordance with present Embodiment 1 and the liquid crystal display device including such a liquid crystal panel may be arranged as in (1-1) to (1-11) below.

(1-1) The liquid crystal panel 10 in accordance with present Embodiment 1 includes: a pair of substrates 20 and 30 provided opposite each other with a cell gap (prescribed substrate-to-substrate distance) G between the substrates; a plurality of pixels 91 arranged in a matrix on a face of the substrates 20 and 30, the pixels 91 including pixel sections 90 including at least green pixel sections (an example of first pixel sections) 90-G that give off a green color (an example of a specific color) and red pixel sections (an example of second pixel sections) 90-R that give off a red color; inter-pixel-section light-blocking sections 41 provided on the CF substrate (at least one of the substrates) 20 in such a manner as to provide partitions between adjacent pixel sections 90; spacers 50 arranged, between the substrates 20 and 30, in locations over the inter-pixel-section light-blocking sections 41 in a plan view (when viewed normal to the substrates 20 and 30); and extended light-blocking sections 42 provided so as to extend inward of the pixel sections 90 from the inter-pixel-section light-blocking sections 41, to shield regions surrounding the spacers 50 from light, wherein the spacers 50 include: main spacers (an example of first spacers) 50M interposed between the substrates 20 and 30 in such a manner as to be in contact with both the substrates 20 and 30 when in a natural state, to regulate the cell gap G; at least one larger subspacer (an example of second spacers) 50SA provided on the CF substrate 20 so as to project toward an array substrate (the other substrate) 30, the at least one larger subspacer having a projection length P_{S} smaller than the cell gap G; and smaller subspacers (an example of third spacers) 50SB provided on the CF substrate 20 so as to project toward the array substrate 30, the smaller subspacers having a projection length P_{S} smaller than the cell gap G and having a smaller footprint than does the at least one larger subspacer 50SA in a plan view.

The liquid crystal panel 10, structured as above, displays prescribed images by a plurality of pixels 91 including pixel sections 90 including at least green pixel sections 90-G and red pixel sections 90-R and restricts, for example, color mixing between adjacent pixel sections 90 owing to the inter-pixel-section light-blocking sections 41. In this structure, the liquid crystal panel 10 includes the main spacers 50M for maintaining the cell gap G and further includes, as subspacers for delivering surface pressure resistance, at least two, larger and smaller, types of spacers (larger subspacers 50SA and smaller subspacers 50SB) with different footprints when viewed normal to the substrates 20 and 30. The “natural state” as used above refers to a normal state, which is a state where no temporary external force is being exerted on the liquid crystal panel 10. The “footprint” as used above refers to the area encircled by a profile line of the region where a structural element in question is disposed when viewed normal to the substrates 20 and 30. The “footprint” of the spacer in accordance with the present embodiment refers to the area of the bottom of the spacer 50 projecting from the CF substrate 20. The larger subspacers 50SA and the smaller subspacers 50SB have different footprints and hence require different spacer light-blocking regions. These larger and smaller subspacers 50SA and 50SB, if properly combined and arranged in view of, for example, the shape of the inter-pixel-section light-blocking sections 41 and the balance between the layout of the larger and smaller subspacers 50SA and 50SB and the layout of the main spacers 50M, can therefore suppress the footprint of the extended light-blocking sections 42, thereby increasing the aperture ratio of the pixel sections 90 and suppressing decrease in luminance, while maintaining image display quality and securing the surface pressure resistance required of the liquid crystal panel 10 with a predetermined or greater total subspacer footprint. For instance, the subspacer-use extended light-blocking sections 42SA and 42SB are in some cases formed including, as well as spacer light-blocking regions, dummy regions for reducing aperture ratio differences between the pixel sections 90 to maintain image display quality. The larger subspacers 50SA and the smaller subspacers 50SB, if arranged in the pixel sections 90 with a good balance, can reduce the dummy regions required to keep aperture ratio differences less than or equal to a prescribed level, thereby preventing the subspacer-use extended light-blocking sections 42SA and 42SB from being expanded, and suppress decrease in aperture ratio as a whole.

(1-2) In the liquid crystal panel 10 in accordance with the present embodiment, the main spacers 50M are provided so as to assume prescribed positions relative to the pixel sections 90 in a plan view, and the at least one larger subspacer 50SA includes a plurality of larger subspacers 50SA some of which are arranged so as to assume the prescribed positions relative to the pixel sections 90 in a plan view. Decreases in the aperture ratio of the main-spacer-adjoining pixel sections 90M can be effectively rendered less visually recognizable by providing, for example, extended light-blocking sections (dummies) in the same positions relative to the pixel sections 90 that give off red, green, and blue colors as the main-spacer-use extended light-blocking sections 42M. In this structure, the larger subspacers 50SA, which require the relatively large, larger subspacer-use extended light-blocking sections 42SA, are provided so as to assume the same positions relative to the pixel sections 90 that give off a specific color as the main spacers 50M. This particular arrangement can render local decreases in luminance less visually recognizable in the main-spacer-adjoining pixel sections 90M and suppress degradation of image display quality while reducing the dummy regions in the extended light-blocking sections. In other words, the provision of the larger subspacers 50SA in the same positions relative to the pixel sections 90 as the main spacers 50M enables the larger subspacer-use extended light-blocking sections 42SA to also serve as extended light-blocking sections for eliminating aperture ratio differences from the main-spacer-adjoining pixel sections 90M.
(1-3) In the liquid crystal panel 10 in accordance with the present embodiment, more than half of the larger subspacers 50SA are arranged so as to assume the prescribed positions relative to the pixel sections in a plan view. In this structure, the main spacers 50M are arranged so as to be mixed in among the larger subspacers 50SA that are numerously provided, for example, with a predetermined concentration. This particular arrangement can render local decreases in luminance even less visually recognizable in the main-spacer-adjoining pixel sections 90M.
(1-4) In the liquid crystal panel 10 in accordance with the present embodiment, the pixel sections 90 include at least two pixel sections arranged next to each other in an X-axis direction (row direction) and at least two pixel sections arranged next to each other in a Y-axis direction (column direction), the inter-pixel-section light-blocking sections 41 are arranged to form a lattice, at least the main spacers 50M and the at least one larger subspacer 50SA, among the spacers 50, are provided at intersecting portions 41A of the inter-pixel-section light-blocking sections 41, and the main-spacer-use extended light-blocking sections 42M and the larger subspacer-use extended light-blocking sections 42SA for the main spacers 50M and the at least one larger subspacer 50SA are provided so as to extend inward of four of the pixel sections 90 adjacent to the intersecting portions 41A. In this structure, the main spacers 50M and the larger subspacers 50SA, which require relatively large spacer light-blocking sections, are provided in the intersecting portions 41A of the latticed inter-pixel-section light-blocking sections 41. This particular arrangement increases the portions of these spacer light-blocking sections that are contained in the inter-pixel-section light-blocking sections 41, thereby restraining the footprint of the extended light-blocking sections 42. The structure can hence reduce the area of the individual extended light-blocking sections 42 while maintaining light-blocking capability equivalent to that of the structure in which these spacers are provided in locations outside the intersecting portions 41A, and suppress decreases in the aperture ratio of the pixel sections 90 where the extended light-blocking sections 42 are disposed. In particular, if the four extended light-blocking sections 42 contiguous to the same intersecting portions 41A are formed to have equal areas, irregular aperture ratios are suppressed in the pixel sections 90, which leads to high image display quality.
(1-5) In the liquid crystal panel 10 in accordance with the present embodiment, the smaller subspacers 50SB outnumber the at least one larger subspacer 50SA. Since the smaller subspacers 50SB have a smaller footprint than the larger subspacers 50SA, the smaller subspacers 50SB require smaller spacer light-blocking sections in maintaining image display quality than do the larger subspacers 50SA. In this structure, the larger subspacers 50SA are provided in some of the inter-pixel-section light-blocking sections 41 that are in locations where, for example, relatively large areas are available or the aperture ratios of the pixel sections 90 adjacent to this are preferably reduced for the purpose of ensuring image display quality, whereas the smaller subspacers 50SB are provided in large numbers in those inter-pixel-section light-blocking sections 41 that are in the other locations. This particular arrangement can suppress the footprint of the extended light-blocking sections 42, thereby increasing the aperture ratio of the liquid crystal panel 10, while maintaining image display quality and surface pressure resistance.
(1-6) In the liquid crystal panel 10 in accordance with the present embodiment, among the pixel sections 90, the green pixel sections 90-G and the red pixel sections 90-R are repeatedly arranged in a prescribed order in an X-axis direction, whereas either the green pixel sections 90-G or the red pixel sections 90-R are repeatedly arranged in a column direction, and the at least one larger subspacer 50SA and the smaller subspacers 50SB are arranged in a fixed manner in the X- and Y-axis directions of the pixel sections 90, to form a lattice. In this structure, the larger subspacers 50SA, which require the relatively large, larger subspacer-use extended light-blocking sections 42SA, are provided in the liquid crystal panel 10 with a predetermined concentration. The extended light-blocking sections 42 are hence distributed in the liquid crystal panel 10. This particular arrangement can maintain image display quality and secure stable surface pressure resistance across the entire liquid crystal panel 10.
(1-7) In the liquid crystal panel 10 in accordance with the present embodiment, the main spacers 50M are provided in locations where some of the at least one larger subspacer 50SA are replaced as described earlier. In this structure, the main spacers 50M, which require the large, main-spacer-use extended light-blocking sections 42M, are provided in the same positions relative to the pixel sections 90 that give off a specific color as the larger subspacers 50SA which require the relatively large, larger subspacer-use extended light-blocking sections 42SA, which renders local decreases in luminance less visually recognizable in the main-spacer-adjoining pixel sections 90M.
(1-8) In the liquid crystal panel 10 in accordance with the present embodiment, for each of the pixels 91, a fixed total number (four) of the main spacers 50M and the at least one larger subspacer 50SA is provided in the inter-pixel-section light-blocking section 41 adjacent to the pixel sections 90 in that pixel 91. In this structure, the total number of the main spacers 50M and the larger subspacers 50SA, both of which require relatively large, spacer light-blocking sections, is fixed in the inter-pixel-section light-blocking section 41 adjacent to the pixel sections 90 in each pixel 91. This particular arrangement can render the aperture ratios of the pixels 91 approximately equal to each other, thereby suppressing irregular color and luminance and maintaining high image display quality.
(1-9) In the liquid crystal panel 10 in accordance with the present embodiment, the pixel sections 90 further include blue pixel sections (an example of third pixel sections) 90-B that give off a different color than do the green pixel sections 90-G and the red pixel sections 90-R, the green pixel sections 90-G contribute more to panel transmittance than do the red pixel sections 90-R and the blue pixel sections 90-B, and the main spacers 50M are provided in those inter-pixel-section light-blocking sections 41 that are adjacent to either the red pixel sections 90-R or the blue pixel sections 90-B. In this structure, the main spacers 50M are provided in locations facing either the red pixel sections 90-R or the blue pixel sections 90-B, which can suppress the main spacers 50M in locations facing the green pixel sections 90-G. This particular arrangement can suppress the extended light-blocking sections 42 disposed in the green pixel sections 90-G that contribute relatively much to panel transmittance, thereby suppressing decreases in the aperture ratio of the green pixel sections 90-G and maintaining a high panel transmittance. The main spacers 50M are not disposed in the inter-pixel-section light-blocking sections 41 adjacent to the green pixel sections 90-G in the present embodiment, which is preferable in maintaining the aperture ratios of the green pixel sections 90-G at a high level and thereby effectively suppressing decrease in panel transmittance.
(1-10) In the liquid crystal panel 10 in accordance with the present embodiment, the at least one larger subspacer 50SA is provided in those inter-pixel-section light-blocking sections 41 that are adjacent to either the red pixel sections 90-R or the blue pixel sections 90-B. In this structure, the larger subspacers 50SA are provided in locations facing the red pixel sections 90-R or the blue pixel sections 90-B, which can suppress the larger subspacers 50SA in locations facing the green pixel sections 90-G. This particular arrangement can suppress the extended light-blocking sections 42 disposed in the green pixel sections 90-G that contribute relatively much to panel transmittance, thereby suppressing decreases in the aperture ratio of the green pixel sections 90-G and maintaining a high panel transmittance. The larger subspacers 50SA are not disposed in the inter-pixel-section light-blocking sections 41 adjacent to the green pixel sections 90-G in the present embodiment, which is preferable in maintaining the aperture ratios of the green pixel sections 90-G at a high level and thereby effectively suppressing decrease in panel transmittance.
(1-11) The liquid crystal display device 1 in accordance with the present embodiment includes the liquid crystal panel 10 described in any of paragraphs (1-1) to (1-10) above. This structure can provide a high-luminance display device with excellent image display quality and surface pressure resistance.

### Embodiment 2

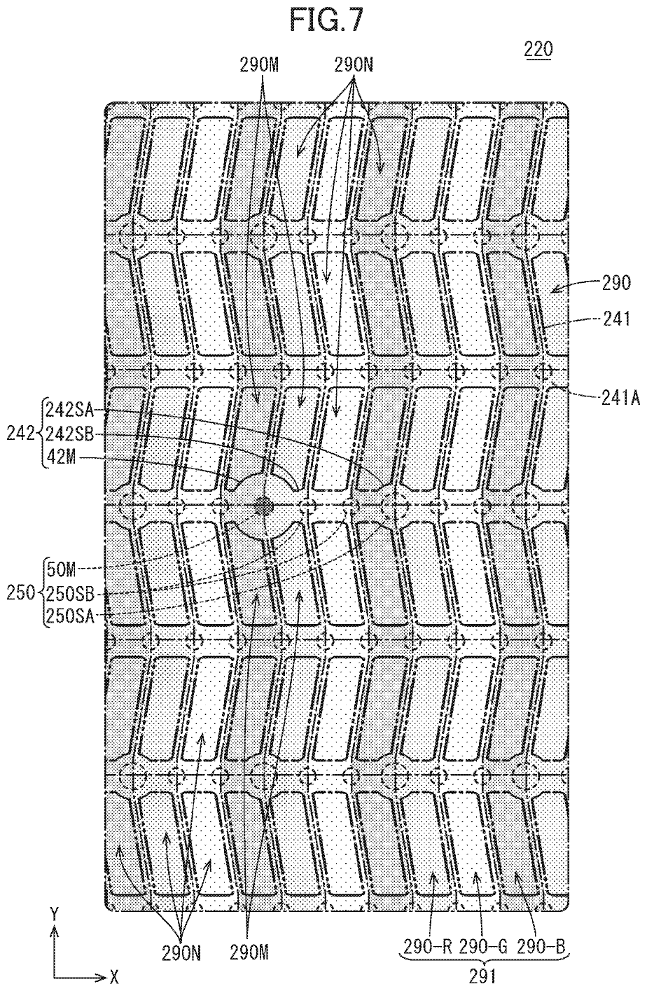

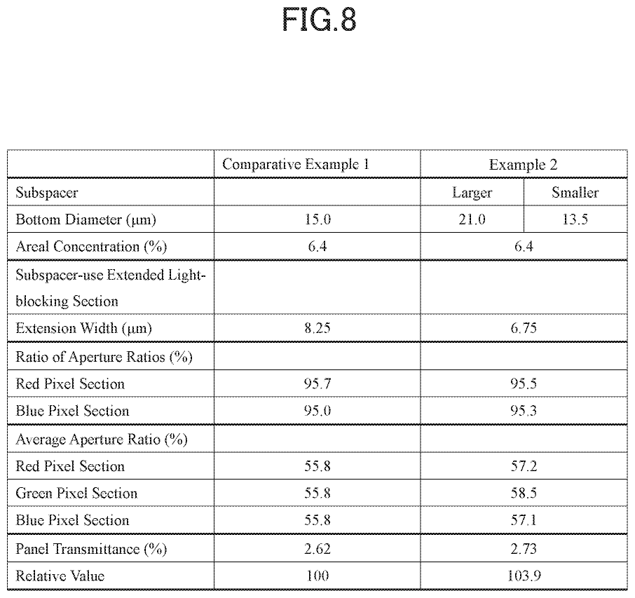

Embodiment 2 will be described now with reference to FIGS. 7 and 8. Present Embodiment 2 will take, as an example, a liquid crystal panel in which the layout of larger subspacers 250SA and smaller subspacers 250SB is changed with larger subspacer-use extended light-blocking sections 242SA and smaller subspacer-use extended light-blocking sections 242SB being arranged in accordance with the new layout. The liquid crystal panel in accordance with Embodiment 2 has the same basic structure as Embodiment 1. Members and structures of present Embodiment 2 that have identical or equivalent counterparts in Embodiment 1 are indicated by the same reference numerals, and description thereof is omitted. The same convention applies to Embodiment 3 and subsequent embodiments.

Referring to FIG. 7, in a CF substrate 220 in accordance with the present embodiment, the larger subspacers 250SA are provided in every other row, so that the number of the larger subspacers 250SA and the number of the smaller subspacers 250SB has a ratio of approximately 1:5. Basically, every other row includes smaller subspacers 250SB exclusively, and the other rows include larger subspacers 250SA and smaller subspacers 250SB in the order of a larger subspacer 250SA, a smaller subspacer 250SB, and another smaller subspacer 250SB in a repeated manner when traced along the X-axis direction. Meanwhile, every three columns include larger subspacers 250SA and smaller subspacers 250SB alternately when traced along the Y-axis direction, and the other columns include smaller subspacers 250SB exclusively. Pixel sections 290 include red pixel sections 290-R, green pixel sections 290-G, and blue pixel sections 290-B and are arranged in the same manner as the pixel sections 90 in Embodiment 1. All the columns that include the larger subspacers 250SA are disposed in intersecting portions 241A between the red pixel sections 290-R and the blue pixel sections 290-B. The smaller subspacers 250SB are disposed in all those intersecting portions 241A that are adjacent to the green pixel sections 290-G.

The main spacers 50M in accordance with the present embodiment are disposed in locations where basically, the larger subspacers 250SA, among the subspacers 250SA and 250SB arranged in the prescribed order, are replaced. As in Embodiment 1, there is provided a very small number of main spacers 50M in the liquid crystal panel in accordance with the present embodiment, and all the main spacers 50M are disposed in the intersecting portions 241A located between the red pixel sections 290-R and the blue pixel sections 290-B. In each inter-pixel-section light-blocking section 241 adjacent to the pixel section 290 included in the pixels 291 each of which includes a set of a red pixel section 290-R, a green pixel section 290-G, and a blue pixel section 290-B arranged next to each other in the X-axis direction, there are provided a total of two main spacers 50M and a total of two larger subspacers 250SA. Unlike in Embodiment 1 where the main spacers 50M are adjacent to the larger subspacers 50SA when traced along the column direction, spacers 250 adjacent to the main spacers 50M are all smaller subspacers 250SB, not only when traced along the row direction and the column direction, but also when traced along oblique directions, in the present embodiment.

In the structure of the present embodiment where the main spacers 50M and the subspacers 250SA and 250SB are arranged as described above, the large main-spacer-use extended light-blocking sections 42M are provided in the blue pixel sections 290-B and the red pixel sections 290-R which are main-spacer-adjoining pixel sections 290M. The medium-sized, larger subspacer-use extended light-blocking sections 242SA are also provided in the blue pixel sections 290-B and the red pixel sections 290-R. In contrast, only the small, smaller subspacer-use extended light-blocking sections 242SB are provided in the green pixel sections 290-G. Unlike in Embodiment 1, no larger subspacer-use extended light-blocking sections 242SA are provided in the main-spacer-adjoining pixel sections 290M in the present embodiment. Except for the main-spacer-use extended light-blocking sections 42M, only the smaller subspacer-use extended light-blocking sections 242SB are provided in the main-spacer-adjoining pixel sections 290M.

### Verification Experiment 2

Verification Experiment 2 was conducted as follows to investigate the effects, on panel transmittance, of the provision described above of the main spacers 50M, the larger subspacers 250SA, and the smaller subspacers 250SB. In present Verification Experiment 2, a liquid crystal panel including the CF substrate 220 in accordance with present Embodiment 2 (see, for example, FIG. 7) was used as Example 2. Comparative Example 1 was the same liquid crystal panel as the one used in Verification Experiment 1.

In the liquid crystal panel of Example 2, the spacers 250 were adjusted, for example, in dimensions, shape, and numbers as shown in the table in FIG. 8 as in Comparative Example 1 so as to have a subspacer areal concentration of 6.4%. This adjustment ensured predetermined surface pressure resistance in the liquid crystal panel of Example 2. Specifically, the subspacers 150S in accordance with Comparative Example 1 were formed to have a bottom diameter of 15.0 whereas the larger subspacers 250SA and the smaller subspacers 250SB in accordance with Example 2 were formed to have respective bottom diameters of 21.0 μm and 13.5 μm. Since the liquid crystal panel of Example 2 included fewer larger subspacers 250SA than the liquid crystal panel of Example 1, the smaller subspacers 250SB were formed to have a slightly larger footprint.

The subspacer-use extended light-blocking sections 242SA and 242SB were also provided in the liquid crystal panel of Example 2 in such a manner that the ratio of the aperture ratio of the main-spacer-adjoining pixel sections 290M to the aperture ratio of main-spacer-non-adjoining pixel sections 290N was greater than or equal to 95%. Specifically, all the larger subspacer-use extended light-blocking sections 242SA and the smaller subspacer-use extended light-blocking sections 242SB were provided so as to have an extension width of 6.75 μm from the peripheries of the larger subspacers 250SA or the smaller subspacers 250SB as shown in the table in FIG. 8, so that the ratio of aperture ratios was greater than or equal to 95.3%. As described earlier in relation to Verification Experiment 1, in the liquid crystal panel of Comparative Example 1, the subspacer-use extended light-blocking sections 142S were provided so as to have an extension width of 8.25 μm from the peripheries of the subspacers 150S.

An average aperture ratio was calculated of the RGB pixel sections 290 and 190 of the liquid crystal panels of Example 2 and Comparative Example 1. In addition, a panel transmittance was measured on the liquid crystal panels. Results are shown in the table in FIG. 8. Liquid crystal display devices were prepared by mounting a backlight unit to the liquid crystal panels. The luminance of the image display area was measured on these liquid crystal display devices while the liquid crystal display devices were producing a white display. The panel transmittance, expressed in percentage, was obtained by dividing the measured luminance by the luminance of the backlight unit alone. The table in FIG. 8 additionally lists the panel transmittance obtained in Example 2 in a relative value by taking the panel transmittance obtained in Comparative Example 1 as being equal to 100.

The table in FIG. 8 shows that the average aperture ratios of the color pixel sections 290-R, 290-G, and 290-B in Example 2 were all higher than the average aperture ratios of the color pixel sections 190-R, 190-G, and 190-B in the liquid crystal panel of Comparative Example 1. This is presumably because the two types of subspacers, that is, the larger subspacers 250SA and the smaller subspacers 250SB, were designed to have such sizes as to strike a suitable balance and arranged to face the main-spacer-adjoining pixel sections 290M and the main-spacer-non-adjoining pixel sections 290N in a well-balanced manner across the entire liquid crystal panel. This design achieved the target ratio of aperture ratios of greater than or equal to 95% and still reduced the required extension width to 6.75 μm in the subspacer-use extended light-blocking sections 242SA and 242SB in Example 2 over the extension width of 8.25 μm in the subspacer-use extended light-blocking sections 142S in Comparative Example 1. The design could hence suppress the dummy regions in the subspacer-use extended light-blocking sections 242SA and 242SB, which in turn likely reduced the footprint of the light-blocking layer across the entire liquid crystal panel and increased the average aperture ratio of the color pixel sections 290-R, 290-G, and 290-B.

The table in FIG. 8 further shows that the average aperture ratios calculated of the red pixel sections 190-R, the green pixel sections 190-G, and the blue pixel sections 190-B were approximately equal in Comparative Example 1 and that in contrast, the average aperture ratio of the green pixel sections 290-G was higher than the average aperture ratios of the red pixel sections 290-R and the blue pixel sections 290-B in Example 2. This was because the larger subspacers 250SA with a large footprint were disposed in the intersecting portions 241A adjacent to the red pixel sections 290-R or the blue pixel sections 290-B and were not disposed in the intersecting portions 241A adjacent to the green pixel sections 290-G. The reasons were that the main-spacer-use extended light-blocking sections 42M and the larger subspacer-use extended light-blocking sections 242SA, which were large, were provided in the red pixel sections 290-R and the blue pixel sections 290-B and that only the smaller subspacer-use extended light-blocking sections 242SB, which were all small, were provided in the extended light-blocking sections 242 in the green pixel sections 290-G. As described earlier, the green pixel sections 290-G contributed more to the panel transmittance than did the red pixel sections 290-R and the blue pixel sections 290-B. Thus, in the liquid crystal panel of Example 2 where the green pixel sections 290-G had an increased aperture ratio, the panel transmittance was efficiently improved by approximately 3.9% over the liquid crystal panel of Comparative Example 1.

As described so far, the liquid crystal panel in accordance with present Embodiment 2 and the liquid crystal display device including such a liquid crystal panel may be arranged as in (1-1) to (1-11) in Embodiment 1, thereby achieving advantages similar to those described above, and may be additionally arranged as in (2-1) below.

(2-1) In the liquid crystal panel in accordance with present Embodiment 2, those inter-pixel-section light-blocking sections 241 that are adjacent to the main-spacer-adjoining pixel sections 290M include no larger subspacers 250SA. In this structure, no relatively large, larger subspacer-use extended light-blocking sections 242SA are provided in the main-spacer-adjoining pixel sections 290M the aperture ratio of which is inevitably reduced due to the provision of the large main-spacer-use extended light-blocking sections 42M. This in turn reduces the extended light-blocking sections 242 in the main-spacer-adjoining pixel sections 290M, thereby suppressing decreases in the aperture ratio of the main-spacer-adjoining pixel sections 290M. The structure can hence maintain the ratio of the aperture ratio of the main-spacer-adjoining pixel sections 290M to the aperture ratio of the main-spacer-non-adjoining pixel sections 290N at a high level and suppress local decreases in luminance in the main-spacer-adjoining pixel sections 290M while suppressing the dummy regions in the subspacer-use extended light-blocking sections 242SA and 242SB, thereby ensuring excellent image display quality.

### Embodiment 3

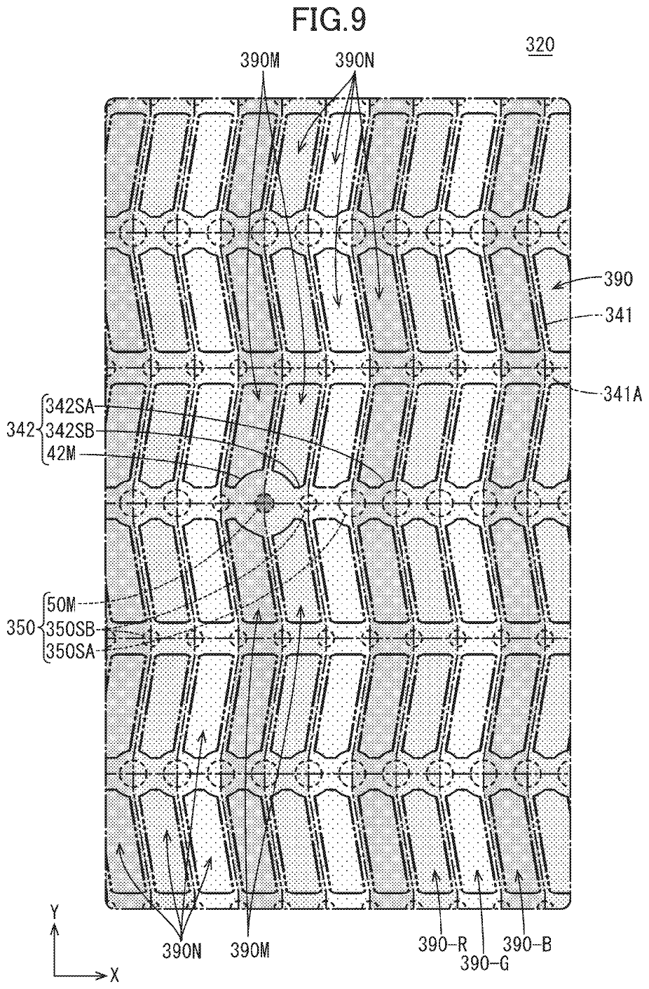

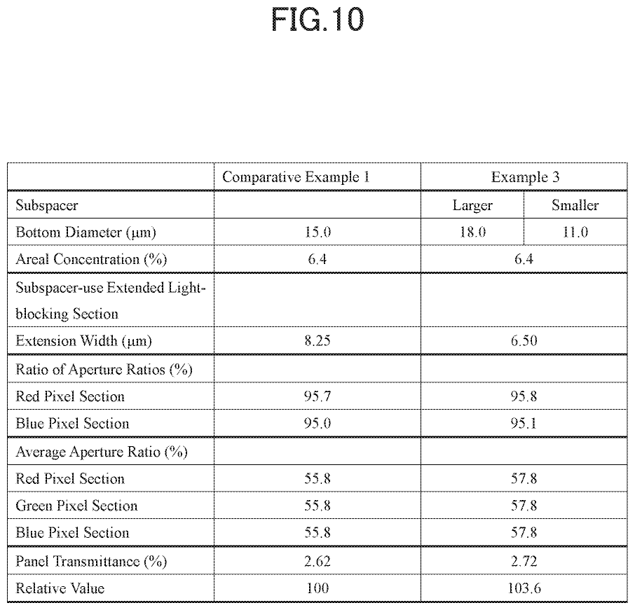

Embodiment 3 will be described now with reference to FIGS. 9 and 10. Present Embodiment 3 takes, as an example, a liquid crystal panel in which the layout of larger subspacers 350SA and smaller subspacers 350SB is changed with larger subspacer-use extended light-blocking sections 342SA and smaller subspacer-use extended light-blocking sections 342SB being arranged in accordance with the new layout.

Referring to FIG. 9, in a CF substrate 320 in accordance with the present embodiment, basically, a row including larger subspacers 350SA exclusively when traced along the X-axis direction and a row including smaller subspacers 350SB exclusively when traced along the X-axis direction are alternately arranged. The ratio of the number of the larger subspacers 350SA to the number of the smaller subspacers 350SB is approximately equal to 1:1. Each column includes larger subspacers 350SA and smaller subspacers 350SB alternately when traced along the Y-axis direction. Red pixel sections 390-R, green pixel sections 390-G, and blue pixel sections 390-B are arranged in the same manner as the pixel sections 90 in Embodiment 1. The larger subspacers 350SA and the smaller subspacers 350SB are arranged to assume substantially the same positions relative to the RGB pixel sections 390.

The main spacers 50M in accordance with the present embodiment are disposed in locations where basically, the larger subspacers 350SA, among the subspacers 350SA and 350SB arranged in the prescribed order, are replaced. As in Embodiment 1, there is provided a very small number of main spacers 50M in the liquid crystal panel in accordance with the present embodiment, and all the main spacers 50M are preferably disposed in intersecting portions 341A located between the red pixel sections 390-R and the blue pixel sections 390-B. Additionally, the larger subspacers 350SA are replaced by the smaller subspacers 350SB, so that all those spacers 350 that are adjacent to the main spacers 50M are the smaller subspacers 350SB.

In the structure of the present embodiment where the main spacers 50M and the subspacers 350SA and 350SB are arranged as described above, the large main-spacer-use extended light-blocking sections 42M are provided in the blue pixel sections 390-B and the red pixel sections 390-R which are main-spacer-adjoining pixel sections 390M. As described here, no larger subspacers 350SA, which require the relatively large, larger subspacer-use extended light-blocking sections 342SA, are arranged in inter-pixel-section light-blocking sections 341 adjacent to the main-spacer-adjoining pixel sections 390M where the main-spacer-use extended light-blocking sections 42M are disposed. Except for the main-spacer-use extended light-blocking sections 42M, only the small, smaller subspacer-use extended light-blocking sections 42SB are provided in the inter-pixel-section light-blocking sections 341.

### Verification Experiment 3

Verification Experiment 3 was conducted as follows to investigate the effects, on panel transmittance, of the provision described above of the main spacers 50M, the larger subspacers 350SA, and the smaller subspacers 350SB. In present Verification Experiment 3, a liquid crystal panel including the CF substrate 320 in accordance with present Embodiment 3 (see, for example, FIG. 9) was used as Example 3. Comparative Example 1 was the same liquid crystal panel as the one used in Verification Experiment 1.

In the liquid crystal panel of Example 3, the spacers 350 were adjusted, for example, in dimensions, shape, and numbers as shown in the table in FIG. 10 as in Comparative Example 1 so as to have a subspacer areal concentration of 6.4%. This adjustment ensured predetermined surface pressure resistance in the liquid crystal panel of Example 3. Specifically, the subspacers 150S in accordance with Comparative Example 1 were formed to have a bottom diameter of 15.0 μm, whereas the larger subspacers 250SA and the smaller subspacers 250SB in accordance with Example 3 were formed to have respective bottom diameters of 18.0 μm and 11.0 μm. Since the liquid crystal panel of Example 3 included a greater number of larger subspacers 350SA than the liquid crystal panel of Example 1, the larger subspacers 350SA were formed to have a slightly smaller footprint.

The subspacer-use extended light-blocking sections 342SA and 342SB were also provided in the liquid crystal panel of Example 3 in such a manner that the ratio of the aperture ratio of the main-spacer-adjoining pixel sections 390M to the aperture ratio of main-spacer-non-adjoining pixel sections 390N was greater than or equal to 95%. Specifically, all the larger subspacer-use extended light-blocking sections 342SA and the smaller subspacer-use extended light-blocking sections 342SB were provided so as to have an extension width of 6.50 μm from the peripheries of the larger subspacers 350SA or the smaller subspacers 350SB as shown in the table in FIG. 10, so that the ratio of aperture ratios was greater than or equal to 95.1%. As described earlier in relation to Verification Experiment 1, in the liquid crystal panel of Comparative Example 1, the subspacer-use extended light-blocking sections 142S were provided so as to have an extension width of 8.25 μm from the peripheries of the subspacers 150S.

An average aperture ratio was calculated of the RGB pixel sections 390 and 190 of the liquid crystal panels of Example 3 and Comparative Example 1. In addition, a panel transmittance was measured on the liquid crystal panels. Results are shown in the table in FIG. 10. Liquid crystal display devices were prepared by mounting a backlight unit to the liquid crystal panels. The luminance of the image display area was measured on these liquid crystal display devices while the liquid crystal display devices were producing a white display. The panel transmittance, expressed in percentage, was obtained by dividing the measured luminance by the luminance of the backlight unit alone. The table in FIG. 10 additionally lists the panel transmittance obtained in Example 3 in a relative value by taking the panel transmittance obtained in Comparative Example 1 as being equal to 100.

The table in FIG. 10 shows that the average aperture ratios of the color pixel sections 390-R, 390-G, and 390-B were approximately equal in Example 3 as in Comparative Example 1 and that the aperture ratios of the pixel sections 390 were improved overall in Example 3 over those in Comparative Example 1. This is presumably because the larger subspacers 350SA and the smaller subspacers 350SB, which had different sizes (footprints), were designed to have such sizes as to strike a suitable balance and arranged to face the main-spacer-adjoining pixel sections 390M and the main-spacer-non-adjoining pixel sections 390N in a well-balanced manner across the entire liquid crystal panel. This design achieved the target ratio of aperture ratios of greater than or equal to 95% and still reduced the required extension width to 6.50 μm in the subspacer-use extended light-blocking sections 342SA and 342SB in Example 3 over the extension width of 8.25 μm in the subspacer-use extended light-blocking sections 142S in Comparative Example 1. The design could hence suppress the dummy regions in the subspacer-use extended light-blocking sections 342SA and 342SB, which in turn likely reduced the footprint of the light-blocking layer across the entire liquid crystal panel and overall increased the average aperture ratios of the color pixel sections 390-R, 390-G, and 390-B. When the extension width is 6.50 μm as in present Example 3, it is safely assumed that the subspacer-use extended light-blocking sections include almost no dummy regions for adjusting the ratio of aperture ratios. The panel transmittance was improved by approximately 3.6% in the liquid crystal panel of Example 3 over the liquid crystal panel of Comparative Example 1.

As described so far, the liquid crystal panel in accordance with present Embodiment 3 and the liquid crystal display device including such a liquid crystal panel may be arranged as in (1-1) to (1-4), (1-6) to (1-9), and (1-11) in Embodiment 1, thereby achieving advantages similar to those described above, and may be additionally arranged as in (3-1) below.

(3-1) In the liquid crystal panel in accordance with present Embodiment 3, those inter-pixel-section light-blocking sections 341 that are adjacent to the main-spacer-adjoining pixel sections 390M include no larger subspacers 350SA. In this structure, no larger subspacers 350SA, which require relatively large, larger subspacer-use extended light-blocking sections, are provided in the main-spacer-adjoining pixel sections 390M the aperture ratio of which is inevitably reduced due to the provision of the large main-spacer-use extended light-blocking sections 42M. This in turn suppresses the extended light-blocking sections 342 in the main-spacer-adjoining pixel sections 390M, thereby suppressing decreases in the aperture ratio of the main-spacer-adjoining pixel sections 390M. The structure can hence maintain the ratio of the aperture ratio of the main-spacer-adjoining pixel sections 390M to the aperture ratio of the main-spacer-non-adjoining pixel sections 390N at a high level and suppress local decreases in luminance in the main-spacer-adjoining pixel sections 390M while suppressing the dummy regions in the subspacer-use extended light-blocking sections 342SA and 342SB, thereby ensuring excellent image display quality.

### Embodiment 4

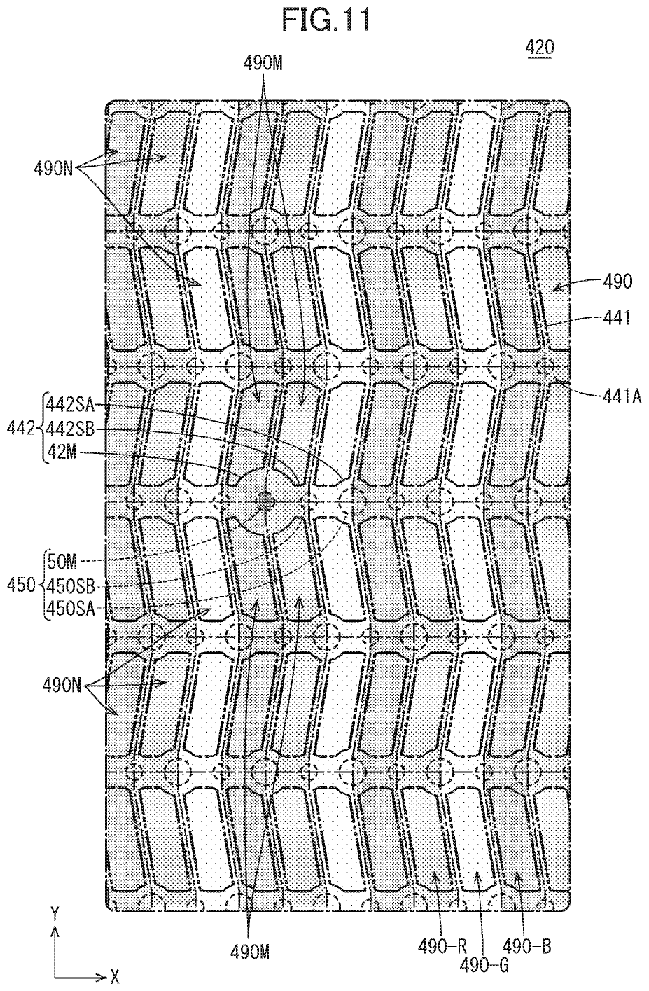

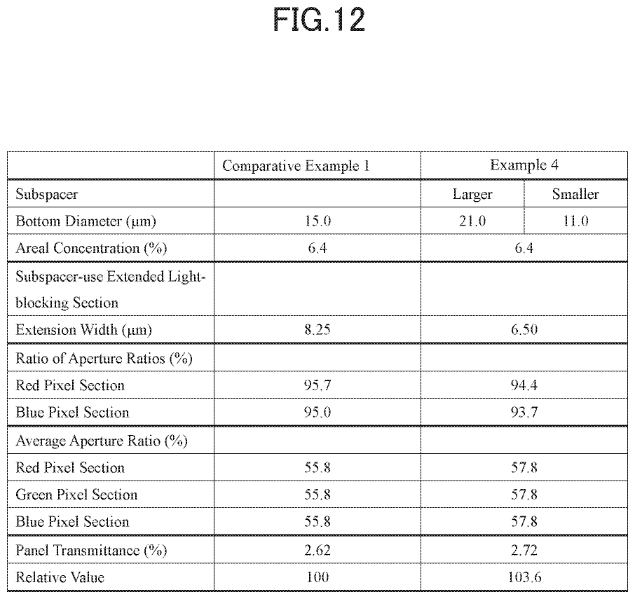

Embodiment 4 will be described now with reference to FIGS. 11 and 12. Present Embodiment 4 takes, as an example, a liquid crystal panel in which the layout of larger subspacers 450SA and smaller subspacers 450SB is changed with larger subspacer-use extended light-blocking sections 442SA and smaller subspacer-use extended light-blocking sections 442SB being arranged in accordance with the new layout.

Referring to FIG. 11, in a CF substrate 420 in accordance with the present embodiment, basically, the larger subspacers 450SA and the smaller subspacers 450SB are arranged in a staggered manner with respect to the X-axis direction and the Y-axis direction. The ratio of the number of the larger subspacers 450SA to the number of the smaller subspacers 450SB is approximately equal to 1:1. The larger subspacers 450SA and the smaller subspacers 450SB are alternately arranged both when traced along the X-axis direction and when traced along the Y-axis direction. For these reasons, the liquid crystal panel of present Embodiment 4 exhibits uniformly high local surface pressure resistance when compared with a liquid crystal panel in which smaller subspacers are arranged successively next to each other. Red pixel sections 490-R, green pixel sections 490-G, and blue pixel sections 490-B are arranged in the same manner as the pixel sections 90 in Embodiment 1. The larger subspacers 450SA and the smaller subspacers 450SB are arranged to assume substantially the same positions relative to the RGB pixel sections 490.

As in Embodiment 1, there is provided a small number of main spacers 50M in the liquid crystal panel in accordance with the present embodiment. The main spacers 50M are disposed in locations where basically, some of the larger subspacers 450SA, among the subspacers 450SA and 450SB arranged in the prescribed order, are replaced. The main spacers 50M are preferably provided in intersecting portions 441A adjacent to the red or blue pixel sections 490. In the present embodiment, there are provided larger subspacers 450SA in those locations of inter-pixel-section light-blocking sections 441 adjacent to four main-spacer-adjoining pixel sections 490M that are diagonal from the main spacers 50M with respect to the main-spacer-adjoining pixel sections 490M.

### Verification Experiment 4

Verification Experiment 4 was conducted as follows to investigate the effects, on panel transmittance, of the provision described above of the main spacers 50M, the larger subspacers 450SA, and the smaller subspacers 450SB. In present Verification Experiment 4, a liquid crystal panel including the CF substrate 420 in accordance with present Embodiment 4 (see, for example, FIG. 11) was used as Example 4. Comparative Example 1 was the same liquid crystal panel as the one used in Verification Experiment 1.

In the liquid crystal panel of Example 4, the spacers 450 were adjusted, for example, in dimensions, shape, and numbers as shown in the table in FIG. 12 as in Comparative Example 1 so as to have a subspacer areal concentration of 6.4%. This adjustment ensured predetermined surface pressure resistance in the liquid crystal panel of Example 4. Specifically, the subspacers 150S in accordance with Comparative Example 1 were formed to have a bottom diameter of 15.0 μm, whereas the larger subspacers 450SA and the smaller subspacers 450SB in accordance with Example 4 were formed to have respective bottom diameters of 18.0 μm and 11.0 μm. Since the liquid crystal panel of Example 4 included a greater number of larger subspacers than the liquid crystal panel of Example 1, the larger subspacers 450SA were formed to have a slightly smaller footprint.

All the subspacer-use extended light-blocking sections 442SA and 442SB were arranged in the liquid crystal panel of present Example 4 so as to have such a size that almost no dummy regions for adjusting the ratio of aperture ratios were contained or more specifically, so that the extension width from the peripheries of the larger subspacers 450SA or the smaller subspacers 450SB was equal to 6.50 μm. As described earlier in relation to Verification Experiment 1, in the liquid crystal panel of Comparative Example 1, the subspacer-use extended light-blocking sections 142S were provided so as to have an extension width of 8.25 μm from the peripheries of the subspacers 150S.

An average aperture ratio was calculated of the RGB pixel sections 490 and 190 of the liquid crystal panels of Example 4 and Comparative Example 1. The ratio of the aperture ratio of the main-spacer-adjoining pixel sections 490M and 190M to the aperture ratio of main-spacer-non-adjoining pixel sections 490N and 190N was calculated. In addition, a panel transmittance was measured on the liquid crystal panels of Example 4 and Comparative Example 1. Results are shown in the table in FIG. 12. Liquid crystal display devices were prepared by mounting a backlight unit to the liquid crystal panels. The luminance of the image display area was measured on these liquid crystal display devices while the liquid crystal display devices were producing a white display. The panel transmittance, expressed in percentage, was obtained by dividing the measured luminance by the luminance of the backlight unit alone. The table in FIG. 12 additionally lists relative values obtained by comparing the panel transmittance obtained in Comparative Example 1 and the panel transmittance obtained in Example 4.

The table in FIG. 12 shows that the average aperture ratios of the color pixel sections 490-R, 490-G, and 490-B were approximately equal in Example 4 as in Comparative Example 1 and that the aperture ratios of the pixel sections 490 were improved overall in Example 4 over those in Comparative Example 1. This is presumably because the subspacer-use extended light-blocking sections 442SA and 442SB included fewer dummy regions so that the light-blocking layer overall had a smaller footprint. Therefore, the panel transmittance was improved by approximately 3.6% in the liquid crystal panel of Example 4 over the liquid crystal panel of Comparative Example 1.

Both the red pixel sections 490-R and the blue pixel sections 490-B had a slightly lower ratio of aperture ratios in the liquid crystal panel of Example 4 than in the liquid crystal panel of Comparative Example 1. Since each inter-pixel-section light-blocking section 441 adjacent to the main-spacer-adjoining pixel section 490M included a larger subspacer 450SA in the present embodiment, the relatively large, larger subspacer-use extended light-blocking sections 442SA, as well as the large main-spacer-use extended light-blocking sections 42M, were provided in the main-spacer-adjoining pixel sections 490M. This specific arrangement presumably reduced the aperture ratio of the main-spacer-adjoining pixel sections 490M. The liquid crystal panel of Example 4 could however also achieve an aperture ratio of greater than or equal to 93% despite that the subspacer-use extended light-blocking sections 442SA and 442SB were arranged so as to contain almost no dummy regions.

As described so far, the liquid crystal panel in accordance with present Embodiment 4 and the liquid crystal display device including such a liquid crystal panel may be arranged as in (1-1) to (1-4), (1-7) to (1-9), and (1-11) in Embodiment 1, thereby achieving advantages similar to those described above, and may be additionally arranged as in (4-1) below.

(4-1) In the liquid crystal panel in accordance with present Embodiment 4, among the pixel sections 490, the green pixel sections (first pixel sections) 490-G and the red pixel sections (second pixel sections) 490-R are repeatedly arranged in a prescribed order in the X-axis direction (in the row direction), whereas either the green pixel sections 490-G or the red pixel sections 490-R are repeatedly arranged in the Y-axis direction (in the column direction), and the at least one larger subspacer (second spacer) 450SA and the smaller subspacers (third spacers) 450SB are arranged in a fixed manner in the X-axis direction of the pixel sections 490 and in a staggered manner by being displaced by one (by a prescribed amount) in the Y-axis direction. In this structure, not only the larger subspacers 450SA, which exhibit higher surface pressure resistance, are distributed in the liquid crystal panel, but the larger subspacers 450SA, which require the relatively large, larger subspacer-use extended light-blocking sections 442SA, are also distributed in the liquid crystal panel at a predetermined concentration. The extended light-blocking sections 442 are hence distributed in the liquid crystal panel. This specific arrangement can further alleviate non-uniform displays, thereby maintaining high image display quality and ensuring uniformly high surface pressure resistance across the entire liquid crystal panel.

### Embodiment 5

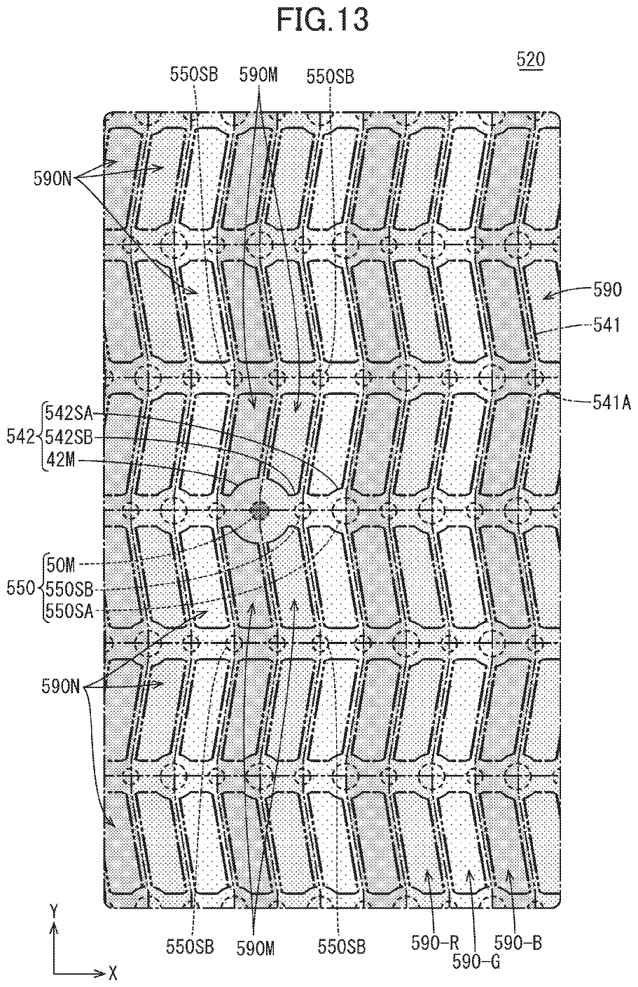

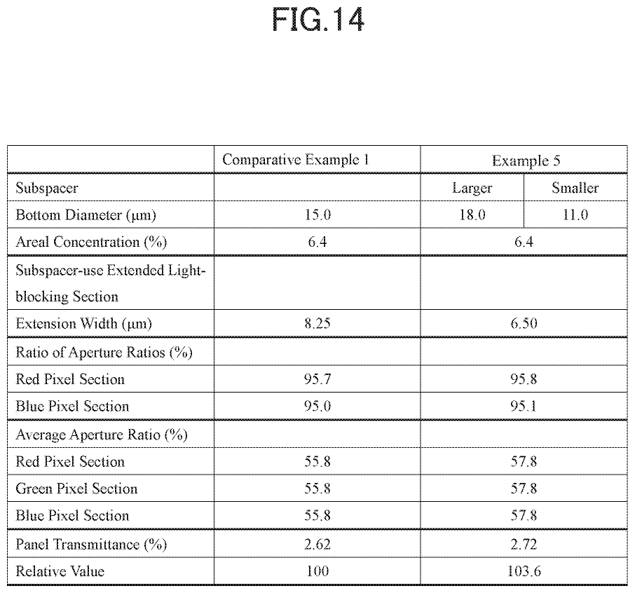

Embodiment 5 will be described now with reference to FIGS. 13 and 14. Present Embodiment 5 takes, as an example, a liquid crystal panel in which the layout of larger subspacers 550SA and smaller subspacers 550SB is changed with larger subspacer-use extended light-blocking sections 542SA and smaller subspacer-use extended light-blocking sections 542SB being arranged in accordance with the new layout.

Referring to FIG. 13, in a CF substrate 520 in accordance with the present embodiment, basically, the larger subspacers 550SA and the smaller subspacers 550SB are arranged in a staggered manner with respect to the X-axis direction and the Y-axis direction similarly to Embodiment 4. The ratio of the number of the larger subspacers 550SA to the number of the smaller subspacers 550SB is approximately equal to 1:1. The larger subspacers 550SA and the smaller subspacers 550SB are alternately arranged both when traced along the X-axis direction and when traced along the Y-axis direction. Red pixel sections 590-R, green pixel sections 590-G, and blue pixel sections 590-B are arranged in the same manner as the pixel sections 90 in Embodiment 1. The larger subspacers 550SA and the smaller subspacers 550SB are arranged to assume substantially the same positions relative to the RGB pixel sections 590.

As in Embodiment 1, there is provided a small number of main spacers 50M in the liquid crystal panel in accordance with the present embodiment. The main spacers 50M are disposed in locations where basically, some of the larger subspacers 550SA, among the subspacers 550SA and 550SB arranged in the prescribed order, are replaced. The main spacers 50M are preferably provided in intersecting portions 541A adjacent to red or blue pixel sections 590. In the present embodiment, those spacers 550, adjacent to the main spacers 50M, that are provided in locations where the larger subspacers 550SA should be originally provided are additionally replaced by the smaller subspacers 550SB. Specifically, for each main spacer 50M, the smaller subspacers 550SB are provided in four locations obliquely adjacent to the main spacer 50M. In the liquid crystal panel of previous Embodiment 4, among the inter-pixel-section light-blocking sections 441 adjacent to the four main-spacer-adjoining pixel sections 490M around the main spacer 50M, the larger subspacers 450SA are provided in the locations that are diagonal from the main spacer 50M with respect to each main-spacer-adjoining pixel section 490M. In contrast, in the present embodiment, all the spacers 550 provided in the inter-pixel-section light-blocking sections 541 adjacent to four main-spacer-adjoining pixel sections 590M are the smaller subspacers 550SB.

In this layout, there are provided no relatively large, larger subspacer-use extended light-blocking sections 542SA in the main-spacer-adjoining pixel sections 590M. Except for the large main-spacer-use extended light-blocking sections 42M, only the small, smaller subspacer-use extended light-blocking sections 542SB are provided in the main-spacer-adjoining pixel sections 590M.

### Verification Experiment 5

Verification Experiment 5 was conducted as follows to investigate the effects, on panel transmittance, of the provision described above of the main spacers 50M, the larger subspacers 550SA, and the smaller subspacers 550SB. In present Verification Experiment 5, a liquid crystal panel including the CF substrate 520 in accordance with present Embodiment 5 (see, for example, FIG. 13) was used as Example 5. Comparative Example 1 was the same liquid crystal panel as the one used in Verification Experiment 1.

In the liquid crystal panel of Example 5, the spacers 550 were adjusted, for example, in dimensions, shape, and numbers as shown in the table in FIG. 14 as in Comparative Example 1 so as to have a subspacer areal concentration of 6.4%. This adjustment ensured predetermined surface pressure resistance in the liquid crystal panel of Example 5. Specifically, the subspacers 150S in accordance with Comparative Example 1 were formed to have a bottom diameter of 15.0 μm, whereas the larger subspacers 550SA and the smaller subspacers 550SB in accordance with Example 5 were formed to have respective bottom diameters of 18.0 μm and 11.0 μm. Since the liquid crystal panel of Example 5 included a greater number of larger subspacers than the liquid crystal panel of Example 1, the larger subspacers 550SA were formed to have a slightly smaller footprint.

All the subspacer-use extended light-blocking sections 542SA and 542SB were arranged in the liquid crystal panel of present Example 5 so as to have such a size that almost no dummy regions for adjusting the ratio of aperture ratios were contained or more specifically, so that the extension width from the peripheries of the larger subspacers 550SA or the smaller subspacers 550SB was equal to 6.50 μm. As described earlier in relation to Verification Experiment 1, in the liquid crystal panel of Comparative Example 1, the subspacer-use extended light-blocking sections 142S were provided so as to have an extension width of 8.25 μm from the peripheries of the subspacers 150S.

An average aperture ratio was calculated of RGB pixel sections 590 and 190 of the liquid crystal panels of Example 5 and Comparative Example 1. The ratio of the aperture ratio of the main-spacer-adjoining pixel sections 590M and 190M to the aperture ratio of the main-spacer-non-adjoining pixel sections 590N and 190N was calculated. In addition, a panel transmittance was measured on the liquid crystal panels of Example 5 and Comparative Example 1. Results are shown the table in FIG. 14. Liquid crystal display devices were prepared by mounting a backlight unit to the liquid crystal panels. The luminance of the image display area was measured on these liquid crystal display devices while the liquid crystal display devices were producing a white display. The panel transmittance, expressed in percentage, was obtained by dividing the measured luminance by the luminance of the backlight unit alone. The table in FIG. 14 additionally lists relative values obtained by comparing the panel transmittance obtained in Comparative Example 1 and the panel transmittance obtained in Example 5.

The table in FIG. 14 shows that the average aperture ratios of the color pixel sections 590-R, 590-G, and 590-B were approximately equal in Example 5 as in Comparative Example 1 and that the aperture ratios of the pixel sections 590 were improved overall in Example 5 over those in Comparative Example 1. This is presumably because the subspacer-use extended light-blocking sections 542SA and 542SB included fewer dummy regions so that the light-blocking layer overall had a smaller footprint. Therefore, the panel transmittance was improved by approximately 3.6% in the liquid crystal panel of Example 5 over the liquid crystal panel of Comparative Example 1.

The ratio of aperture ratios was greater than or equal to 95% for both the red pixel sections 590-R and the blue pixel sections 590-B in the liquid crystal panel of Example 5 as with Comparative Example 1. This is presumably because all the spacers 550 in the inter-pixel-section light-blocking sections 541 adjacent to the main-spacer-adjoining pixel sections 590M were the small, smaller subspacers 550SB, which suppressed the extended light-blocking sections 542 in the main-spacer-adjoining pixel sections 590M. As described here, it is learned that in the liquid crystal panel of Example 5, local decreases in luminance are hardly recognizable in the main-spacer-adjoining pixel sections 590M, a high ratio of aperture ratios can be achieved without having to providing dummy regions in the subspacer-use extended light-blocking sections 542SA and 542SB, and predetermined image display quality is ensured.

As described so far, the liquid crystal panel in accordance with present Embodiment 5 and the liquid crystal display device including such a liquid crystal panel may be arranged as in (1-1) to (1-4), (1-7), (1-9), and (1-11) in Embodiment 1, thereby achieving advantages similar to those described above, and may be additionally arranged as in (5-1) and (5-2) below.

(5-1) In the liquid crystal panel in accordance with present Embodiment 5, among the pixel sections 590, the green pixel sections (first pixel sections) 590-G and the red pixel sections (second pixel sections) 590-R are repeatedly arranged in a prescribed order in the X-axis direction (in the row direction), whereas either the green pixel sections 590-G or the red pixel sections 590-R are repeatedly arranged in the Y-axis direction (in the column direction), and the at least one larger subspacer (second spacer) 550SA and the smaller subspacers (third spacers) 550SB are arranged in a fixed manner in the X-axis direction of the pixel sections 590 and in a staggered manner by being displaced by one (by a prescribed amount) in the Y-axis direction. In this structure, not only the larger subspacers 550SA, which exhibit higher surface pressure resistance, are distributed in the liquid crystal panel, but the larger subspacers 550SA, which require the relatively large, larger subspacer-use extended light-blocking sections 542SA, are also distributed in the liquid crystal panel at a predetermined concentration. The extended light-blocking sections 542 are hence distributed in the liquid crystal panel. This specific arrangement can further alleviate non-uniform displays, thereby maintaining high image display quality and ensuring uniformly high surface pressure resistance across the entire liquid crystal panel.
(5-2) In the liquid crystal panel in accordance with present Embodiment 5, those inter-pixel-section light-blocking sections 541 that are adjacent to the main-spacer-adjoining pixel sections 590M include no larger subspacers 550SA. In this structure, no relatively large, larger subspacer-use extended light-blocking sections 542SA are provided in the main-spacer-adjoining pixel sections 590M the aperture ratio of which is inevitably reduced due to the provision of the large main-spacer-use extended light-blocking sections 42M. This in turn reduces the extended light-blocking sections 542 in the main-spacer-adjoining pixel sections 590M, thereby suppressing decreases in the aperture ratio of the main-spacer-adjoining pixel sections 590M. The structure can hence maintain the ratio of the aperture ratio of the main-spacer-adjoining pixel sections 590M to the aperture ratio of the main-spacer-non-adjoining pixel sections 590N at a high level and suppress local decreases in luminance in the main-spacer-adjoining pixel sections 590M while suppressing the dummy regions in the subspacer-use extended light-blocking sections 542SA and 542SB, thereby ensuring excellent image display quality.

### Embodiment 6

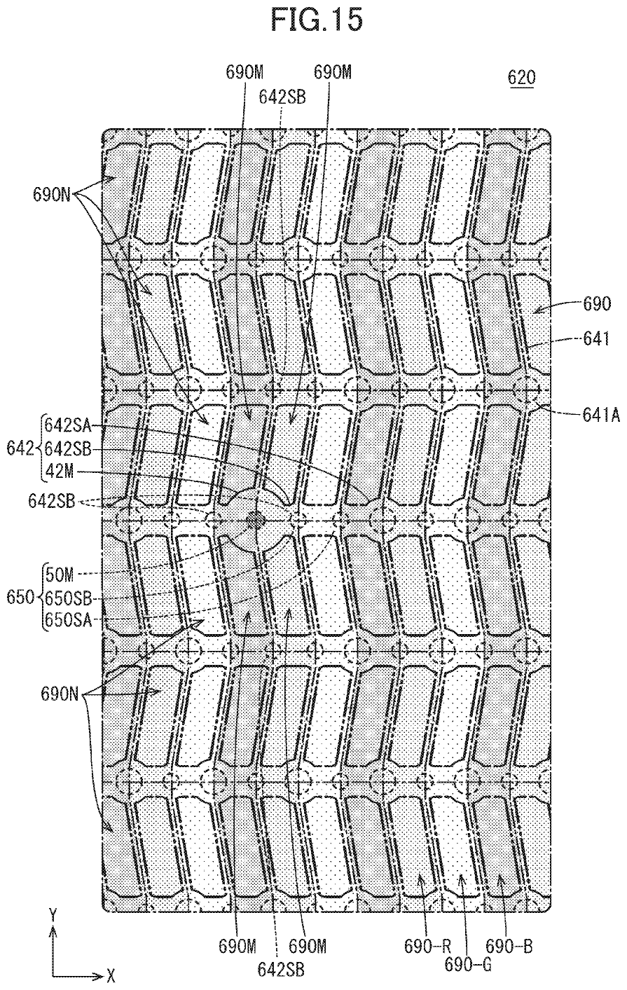

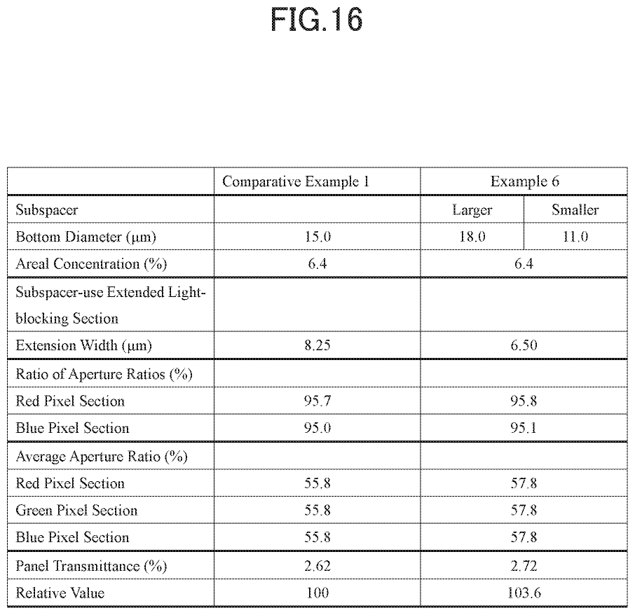

Embodiment 6 will be described now with reference to FIGS. 15 and 16. Present Embodiment 6 takes, as an example, a liquid crystal panel in which the layout of larger subspacers 650SA and smaller subspacers 650SB is changed with larger subspacer-use extended light-blocking sections 642SA and smaller subspacer-use extended light-blocking sections 642SB being arranged in accordance with the new layout.

Referring to FIG. 15, in a CF substrate 620 in accordance with the present embodiment, basically, the larger subspacers 650SA and the smaller subspacers 650SB are arranged in a staggered manner with respect to the X-axis direction and the Y-axis direction similarly to Embodiment 4. The ratio of the number of the larger subspacers 650SA to the number of the smaller subspacers 650SB is approximately equal to 1:1. The larger subspacers 650SA and the smaller subspacers 650SB are alternately arranged both when traced along the X-axis direction and when traced along the Y-axis direction. Red pixel sections 690-R, green pixel sections 690-G, and blue pixel sections 690-B are arranged in the same manner as the pixel sections 90 of Embodiment 1. The larger subspacers 650SA and the smaller subspacers 650SB are arranged to assume substantially the same positions relative to the RGB pixel sections 690.

As in Embodiment 1, there is provided a small number of main spacers 50M in the liquid crystal panel in accordance with the present embodiment. The main spacers 50M are disposed in locations where basically, some of the smaller subspacers 650SB, among the subspacers 650SA and 650SB arranged in the prescribed order, are replaced. The main spacers 50M are preferably provided in intersecting portions 641A adjacent to red or blue pixel sections 690. In the present embodiment, those spacers 650, adjacent to the main spacers 50M, that are provided in locations where the larger subspacers 650SA should be original provided are additionally replaced by the smaller subspacers 650SB. Specifically, for each main spacer 50M, the smaller subspacers 650SB are provided in four locations adjacent to the main spacer 50M with respect to the X-axis direction and the Y-axis direction. As a result, in the present embodiment, all the spacers 650 provided in the inter-pixel-section light-blocking sections 641 adjacent to four main-spacer-adjoining pixel sections 690M are the smaller subspacers 650SB. In the liquid crystal panel of Embodiment 5, the rows and columns flanking the main spacers 50M in the X-axis direction and the Y-axis direction include sites where five smaller subspacers 550SB are successively provided. Local surface pressure resistance could decrease at such sites. In contrast, in the present embodiment, there are no sites where four or more smaller subspacers 650SB are arranged successively next to each other. This arrangement reduces concerns over local surface pressure resistance.

In this layout, there are provided no relatively large, larger subspacer-use extended light-blocking sections 642SA in the main-spacer-adjoining pixel sections 690M. Except for the large main-spacer-use extended light-blocking sections 42M, only the small, smaller subspacer-use extended light-blocking sections 642SB are provided in the main-spacer-adjoining pixel sections 690M.

### Verification Experiment 6

Verification Experiment 6 was conducted as follows to investigate the effects, on panel transmittance, of the provision described above of the main spacers 50M, the larger subspacers 650SA, and the smaller subspacers 650SB. In present Verification Experiment 6, a liquid crystal panel including the CF substrate 620 in accordance with present Embodiment 6 (see, for example, FIG. 15) was used as Example 6. Comparative Example 1 was the same liquid crystal panel as the one used in Verification Experiment 1.

In the liquid crystal panel of Example 6, the spacers 650 were adjusted, for example, in dimensions, shape, and numbers as shown in the table in FIG. 16 as in Comparative Example 1 so as to have a subspacer areal concentration of 6.4%. This adjustment ensured predetermined surface pressure resistance in the liquid crystal panel of Example 6. Specifically, the subspacers 150S in accordance with Comparative Example 1 were formed to have a bottom diameter of 15.0 μm, whereas the larger subspacers 650SA and the smaller subspacers 650SB in accordance with Example 6 were formed to have respective bottom diameters of 18.0 μm and 11.0 μm. Since the liquid crystal panel of Example 6 included a greater number of larger subspacers than the liquid crystal panel of Example 1, the larger subspacers 650SA were formed to have a slightly smaller footprint.

All the subspacer-use extended light-blocking sections 642SA and 642SB were arranged in the liquid crystal panel of present Example 6 so as to have such a size that almost no dummy regions for adjusting the ratio of aperture ratios were contained or more specifically, so that the extension width from the peripheries of the larger subspacers 650SA or the smaller subspacers 650SB was equal to 6.50 μm. As described earlier in relation to Verification Experiment 1, in the liquid crystal panel of Comparative Example 1, the subspacer-use extended light-blocking sections 142S were provided so as to have an extension width of 8.25 μm from peripheries of the subspacers 150S.

An average aperture ratio was calculated of the RGB pixel sections 690 and 190 of the liquid crystal panels of Example 6 and Comparative Example 1. The ratio of the aperture ratio of the main-spacer-adjoining pixel sections 690M and 190M to the aperture ratio of main-spacer-non-adjoining pixel sections 690N and 190N was calculated. In addition, a panel transmittance was measured on the liquid crystal panels of Example 6 and Comparative Example 1. Results are shown in the table in FIG. 16. Liquid crystal display devices were prepared by mounting a backlight unit to the liquid crystal panels. The luminance of the image display area was measured on these liquid crystal display devices while the liquid crystal display devices were producing a white display. The panel transmittance, expressed in percentage, was obtained by dividing the measured luminance by the luminance of the backlight unit alone. The table in FIG. 16 additionally lists relative values obtained by comparing the panel transmittance obtained in Comparative Example 1 and the panel transmittance obtained in Example 6.

The table in FIG. 16 shows that the average aperture ratios of the color pixel sections 690-R, 690-G, and 690-B were approximately equal in Example 6 as in Comparative Example 1 and that the aperture ratios of the color pixel sections 690 were increased overall in Example 6 over those in Comparative Example 1. This is presumably because the subspacer-use extended light-blocking sections 642SA and 642SB included fewer dummy regions so that the light-blocking layer overall had a smaller footprint. Therefore, the panel transmittance was improved by approximately 3.6% in the liquid crystal panel of Example 6 over the liquid crystal panel of Comparative Example 1.

It is learned that the ratio of aperture ratios was greater than or equal to 95% for both the red pixel sections 690-R and the blue pixel sections 690-B in the liquid crystal panel of Example 6 as with Comparative Example 1. This is presumably because all the spacers 650 in the inter-pixel-section light-blocking sections 641 adjacent to the main-spacer-adjoining pixel sections 690M were the small, smaller subspacers 650SB, which suppressed the extended light-blocking sections 642 in the main-spacer-adjoining pixel sections 690M. As described here, it is learned that in the liquid crystal panel of Example 6, local decreases in luminance are hardly recognizable in the main-spacer-adjoining pixel sections 690M, a high ratio of aperture ratios can be achieved without having to providing dummy regions in the subspacer-use extended light-blocking sections 642SA and 642SB, and predetermined image display quality is ensured.

As described so far, the liquid crystal panel in accordance with present Embodiment 6 and the liquid crystal display device including such a liquid crystal panel may be arranged as in (1-1), (1-2), (1-4), (1-9), and (1-11) in Embodiment 1, thereby achieving advantages similar to those described above, and may be additionally arranged as in (6-1) and (6-2) below.

(6-1) In the liquid crystal panel in accordance with present Embodiment 6, among the pixel sections 690, the green pixel sections (first pixel sections) 690-G and the red pixel sections (second pixel sections) 690-R are repeatedly arranged in a prescribed order in the X-axis direction (in the row direction), whereas either the green pixel sections 690-G or the red pixel sections 690-R are repeatedly arranged in the Y-axis direction (in the column direction), and the at least one larger subspacer (second spacer) 650SA and the smaller subspacers (third spacers) 650SB are arranged in a fixed manner in the X-axis direction of the pixel sections 690 and in a staggered manner by being displaced by one (by a prescribed amount) in the Y-axis direction. In this structure, not only the larger subspacers 650SA, which exhibit higher surface pressure resistance, are distributed in the liquid crystal panel, but the larger subspacers 650SA, which require the relatively large, larger subspacer-use extended light-blocking sections 642SA, are also distributed in the liquid crystal panel at a predetermined concentration. The extended light-blocking sections 642 are hence distributed in the liquid crystal panel. This specific arrangement can further alleviate non-uniform displays, thereby maintaining high image display quality and ensuring uniformly high surface pressure resistance across the entire liquid crystal panel.
(6-2) In the liquid crystal panel in accordance with present Embodiment 6, those inter-pixel-section light-blocking sections 641 that are adjacent to the main-spacer-adjoining pixel sections 690M include no larger subspacers 650SA. In this structure, no larger subspacers 650SA, which require relatively large, larger subspacer-use extended light-blocking sections, are provided in the main-spacer-adjoining pixel sections 690M the aperture ratio of which is inevitably reduced due to the provision of the large main-spacer-use extended light-blocking sections 42M. This in turn reduces the extended light-blocking sections 642 in the main-spacer-adjoining pixel sections 690M, thereby suppressing decreases in the aperture ratio of the main-spacer-adjoining pixel sections 690M. The structure can hence maintain the ratio of the aperture ratio of the main-spacer-adjoining pixel sections 690M to the aperture ratio of the main-spacer-non-adjoining pixel sections 690N at a high level and suppress local decreases in luminance in the main-spacer-adjoining pixel sections 690M while suppressing the dummy regions in the subspacer-use extended light-blocking sections 642SA and 642SB, thereby ensuring excellent image display quality.

In addition, in the present embodiment, there are no sites where four or more intersecting portions 641A containing no larger subspacers 650SA are arranged successively next to each other. This arrangement reduces concerns over local surface pressure resistance and ensures uniformly high surface pressure resistance across the entire face of the liquid crystal panel.

### Other Embodiments

The subject technology is by no means limited to the embodiments described in the specification and drawings. The dimensions, shape, and locations of structural elements such as pixel sections, pixels, spacers, and light-blocking sections described in the embodiments are mere examples and may be varied in a suitable manner. For instance, the following embodiments are encompassed in the technical scope of the subject technology.

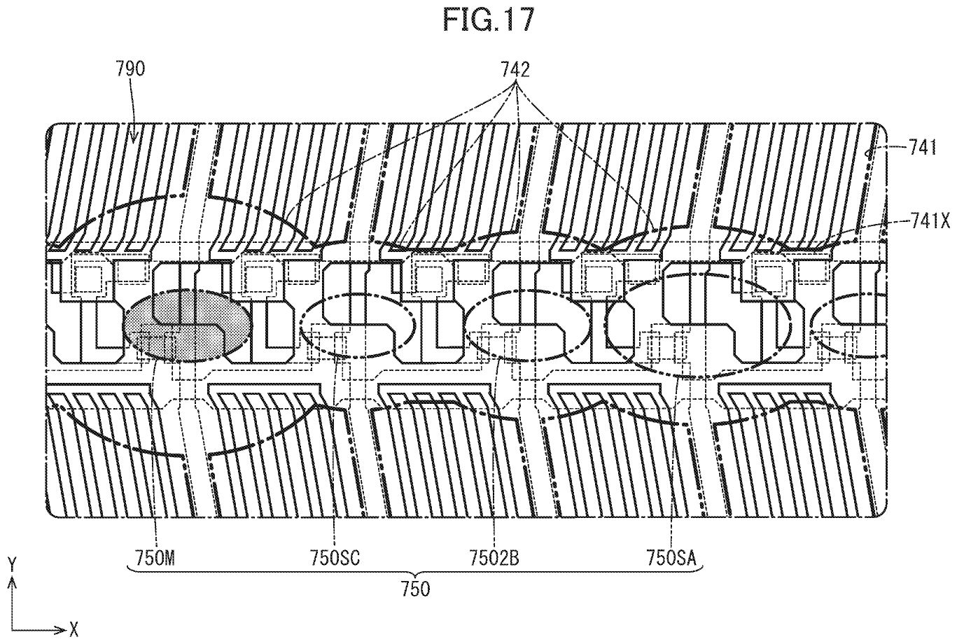

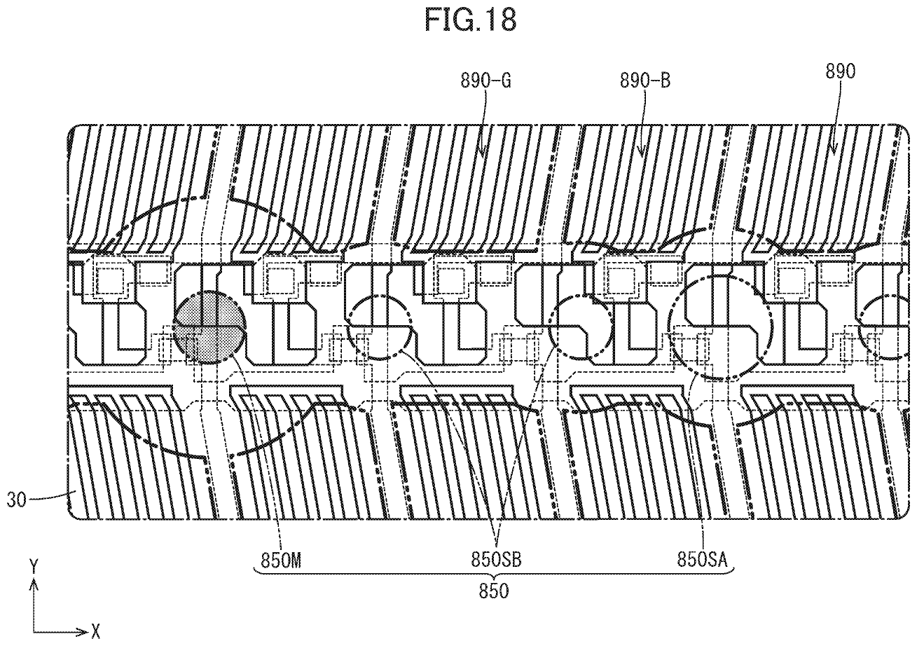

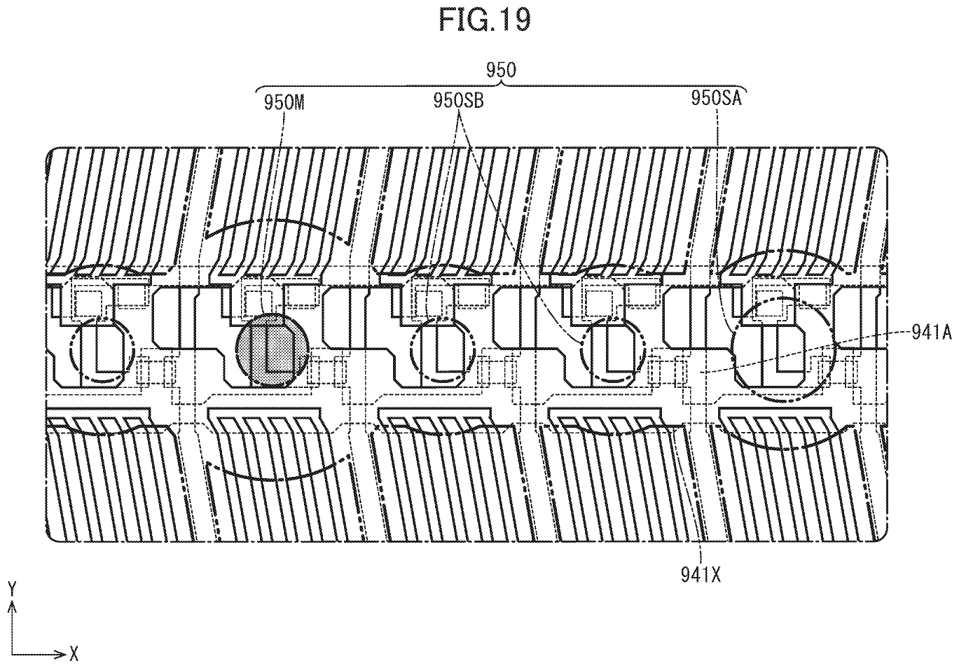

(1) The embodiments above describe, as an example, three types of spacers: the first spacers regulating the substrate-to-substrate distance and the second and third spacers both for providing surface pressure resistances. Alternatively, there may be provided four or more types of spacers. For instance, as will be described later with reference to FIG. 17, fourth and fifth spacers that differ in dimensions and shape from the second and third spacers may be provided as subspacers for providing surface pressure resistance. Spacers that differ in dimensions and shape from the first spacers may be provided as main spacers for regulating the substrate-to-substrate distance.
(2) The embodiments above describe, as an example, all spacers being formed in the shape of a truncated cone, with a circular cross-section, that decreases in diameter toward the projection end. Alternatively, the spacers may be shaped, for example, to have an equal cross-sectional area from the base end to the projection end. As other alternatives, the cross-section may be polygonal (e.g., triangular, quadrilateral, or octagonal) or of an indefinite shape, and/or the footprint width in the X-axis direction may differ from the footprint width in the Y-axis direction. The spacers do not necessarily have similar shapes and may have different shapes. FIG. 17 shows an exemplary in-plane layout of four types of spacers having elliptical cross-sections and mutually different footprints: namely, first spacers 750M, second spacers 750SA, third spacers 750SB, and fourth spacers 750SC. The additional fourth spacers 750SC have a smaller footprint than the third spacers 750SB. Referring to FIG. 17, there is provided an extended light-blocking section 742 inside each pixel section 790 facing the spacer 750. The extended light-blocking section 742 has a size in accordance with the spacer 750. FIG. 17 shows, as an example, that the spacers 750 are arranged along X-axis-direction extensions 741X among inter-pixel-section light-blocking sections. In such a case, the spacers 750 are preferably shaped like an elliptical cone or cylinder having a cross-section with a major axis extending in the X-axis direction because this design expands the spacer light-blocking sections contained in inter-pixel-section light-blocking sections 741.
(3) The embodiments above describe, as an example, the first spacers having a projection length approximately equal to the substrate-to-substrate distance G. Alternatively, for instance, the first spacers may have a projection length smaller than the substrate-to-substrate distance G, there may be provided bases in locations opposite the first spacers on a second substrate disposed opposite a substrate carrying the first spacers thereon, and the first spacers may have a projection end thereof in contact with the base on the second substrate. As another alternative, in locations opposite the projection ends of the second and third spacers, there may be provided bases having such a shape and dimensions as to maintain clearance. As a further alternative, the second and third spacers may have different projection lengths.
(4) The embodiments above describe, as an example, the spacers each being arranged to have a center thereof over an intersection of the X-axis-direction extension of the inter-pixel-section light-blocking section and the centerline of the Y-axis-direction extension thereof. Alternatively, the spacers may each have a center thereof over a position off the centerline. Some or all of the spacers may be displaced off the centerline in this alternative. The spacers may be displaced either in the X-axis direction or in the Y-axis direction. FIG. 18 shows an exemplary in-plane layout of some spacers being displaced in the X-axis direction. In FIG. 18, among spacers 850 arranged in the order of a first spacer 850M, a third spacer 850SB, another third spacer 850SB, and a second spacer 850SA in the X-axis direction, only a third spacer 850SB between another third spacer 850SB and the second spacer 850SA is displaced toward the second spacer 850SA. In this alternative, when pixel sections 890 include first pixel sections 890-G that contribute much to panel transmittance and second pixel sections 890-B that contribute less to panel transmittance than the first pixel sections 890-G, spacers are preferably displaced such that the spacers move away from the first pixel sections 890-G which has a higher panel transmission contribution rate. This arrangement increases the aperture ratio of the first pixel sections 890-G, which in turn could suppress decreases in panel transmittance and improve panel transmittance. The first spacers 850M and the second spacers 850SA, which require large spacer light-blocking sections, are preferably arranged to have centers thereof over intersections of the X-axis-direction extensions of the inter-pixel-section light-blocking sections and the centerlines in the Y-axis-direction extensions thereof in view of suppressing the footprint of the light-blocking layer. Therefore, if only some of the spacers 850 are displaced, it is preferred that the third spacers 850SB, which only require relatively small spacer light-blocking sections, be displaced.
(5) The embodiments above describe, as an example, the spacers each being located in an intersecting portion of the latticed inter-pixel-section light-blocking sections. Alternatively, for instance, as shown in FIG. 19, spacers 950 may be provided in X-axis-direction extensions 941X outside intersecting portions 941A. This layout can be preferable in some cases if individual pixel sections have a large area. If the pixel sections have a small area, the spacers are preferably located in intersecting portions because a predetermined opening area needs to be maintained for each pixel section. FIG. 19 shows the spacers 950 including first spacers 950M, second spacers 950SA, and third spacers 950SB all located outside the intersecting portions 941A. Alternatively, some of them may be provided in the intersecting portions 941A, the others outside the intersecting portions 941A.
(6) The embodiments above describe, as an example, first spacer-use extended light-blocking sections being larger than second spacer-use extended light-blocking sections. Alternatively, the first spacer-use extended light-blocking sections and the second spacer-use extended light-blocking sections may have an equal area. This arrangement is preferable because the display panel can be easily designed in such a manner as to suppress irregular color and luminance.
(7) The embodiments above describe an exemplary case where the four extended light-blocking sections in the four pixel sections facing the intersecting portions where spacers are disposed have an equal area and the same in-plane shape. Alternatively, these four extended light-blocking sections may have different in-plane shapes. As another alternative, there may be provided extended light-blocking sections in only some of the pixel sections facing inter-pixel-section light-blocking sections containing spacers.
(8) The embodiments above describe cases where there are provided three-color (red, blue, and green) coloring section and each pixel includes pixel sections of these three colors. Alternatively, for instance, in place of the three colors or in addition to the three colors, the color filter may include yellow coloring sections that selectively transmit yellow light that has wavelengths in the yellow wavelength region, and the pixel sections may include yellow pixel sections that give off yellow color. As another alternative, the color filter may include a non-coloring section, and the pixel sections may include a transparent pixel section. In such a case, because the transparent pixel section has the highest contribution to panel transmittance, and the yellow pixel sections also have high contribution to panel transmittance, the spacers are preferably arranged so as to increase the aperture ratio of these pixel sections. In addition, in place of these colors or in addition to these colors, there may be provided coloring sections and pixel sections that give off another color.
(9) The arrangement (orders) of the coloring and pixel sections described in the embodiments above may be changed where appropriate. For instance, the coloring and pixel sections may be arranged such that those of the same color are positioned successively next to each other when traced along the X-axis direction and those that give off different colors are positioned repeatedly when traced along the Y-axis direction. Those that give off different colors may be arranged repeatedly both in the X-axis direction and in the Y-axis direction.
(10) The embodiments above describe, as an example, the pixel electrodes and inter-pixel-section light-blocking sections having substantially parallelogram openings. The openings may have another in-plane shape.
(11) The embodiments above describe all spacers being provided on the CF substrate. Alternatively, the spacers may be provided on the array substrate. As another alternative, some of the spacers may be provided on the CF substrate, and the others on the array substrate.
(12) The embodiments above describe the inter-pixel-section light-blocking sections and extended light-blocking sections being provided on the CF substrate. Alternatively, the inter-pixel-section light-blocking sections and extended light-blocking sections may be provided on the array substrate. As another alternative, the inter-pixel-section light-blocking sections and extended light-blocking sections may be provided in a distributed manner on the CF substrate and on the array substrate.
(13) The embodiments above describe the pixel electrodes being provided relatively close to the liquid crystal layer and the common electrode being provided relatively close to the transparent substrate, both on the array substrate. Alternatively, the pixel electrodes and the common electrode may be transposed. The embodiments above describe, as an example, an array substrate being used in liquid crystal panels that operate in FFS (fringe field switching) mode where an in-plane electric field is applied to liquid crystal molecules. The embodiments therefore describe liquid crystal panels including pixel electrodes and a common electrode both formed on an array substrate. The subject technology may alternatively be applied to liquid crystal panels that operate in other modes of operation including IPS (in-plane-switching) mode, VA (vertical alignment) mode, and TN (twisted nematic) mode. The subject technology is also applicable to liquid crystal panels including touch sensor functionality.
(14) The embodiments above describe liquid crystal panels having a vertically elongated rectangular shape in a plan view. The subject technology is also applicable to liquid crystal panels having, for example, a horizontally elongated rectangular shape, a polygonal shape (e.g., a square shape), a circular shape, an elliptical shape, or an indefinite shape in a plan view.
(15) The embodiments above describe, as an example, invert staggered TFTs being provided as switching elements in a liquid crystal panel. Alternatively, the switching elements may be staggered TFTs or non-TFT elements such as thin film diodes (TFDs).
(16) The embodiments above describe, as an example, liquid crystal panels including a liquid crystal layer between a pair of substrates. Alternatively, the subject technology is also applicable to display panels including, between a pair of substrates, a non-liquid crystal material such as an electro-optical material or like functional organic molecules (medium layer). In other words, the subject technology is applicable not only to liquid crystal panels, but also to other types of display panels such as PDPs (plasma display panels), OLED panels, EPD (microencapsulated electrophoretic display) panels, MEMS (microelectro-mechanical system) display panels.

What is claimed is:

1. A display panel comprising:
a pair of substrates provided opposite each other with a prescribed substrate-to-substrate distance between the substrates;
a plurality of pixels arranged in a matrix on a face of the substrates, the pixels including pixel sections including at least first pixel sections that give off a specific color and second pixel sections that give off a different color from the specific color;
inter-pixel-section light-blocking sections provided on at least one of the substrates in such a manner as to provide partitions between adjacent pixel sections;
spacers arranged, between the substrates, in locations over the inter-pixel-section light-blocking sections when viewed normal to the substrates; and
extended light-blocking sections provided so as to extend inward of the pixel sections from the inter-pixel-section light-blocking sections, to shield regions surrounding the spacers from light, wherein
the spacers comprise:
first spacers interposed between the substrates in such a manner as to be in contact with both the substrates when in a natural state, to regulate the substrate-to-substrate distance;
at least one second spacer provided on at least one of the substrates so as to project toward the other substrate, the at least one second spacer having a projection length smaller than the substrate-to-substrate distance; and
third spacers provided on at least one of the substrates so as to project toward the other substrate, the third spacers having a projection length smaller than the substrate-to-substrate distance and having a smaller footprint than does the at least one second spacer when viewed normal to the substrates.

2. The display panel according to claim 1, wherein:
the first spacers are provided so as to assume prescribed positions relative to the pixel sections when viewed normal to the substrates; and
the at least one second spacer comprises a plurality of second spacers some of which are arranged so as to assume the prescribed positions relative to the pixel sections when viewed normal to the substrates.

3. The display panel according to claim 2, wherein more than half of the second spacers are arranged so as to assume the prescribed positions relative to the pixel sections when viewed normal to the substrates.

4. The display panel according to claim 1, wherein:
the pixel sections comprise at least two pixel sections arranged next to each other in a row direction and at least two pixel sections arranged next to each other in a column direction;
the inter-pixel-section light-blocking sections are arranged to form a lattice;
among the spacers, at least the first spacers and the at least one second spacer are provided at intersecting portions of the inter-pixel-section light-blocking sections; and
the extended light-blocking sections for the first spacers and the at least one second spacer are provided so as to extend inward of four of the pixel sections adjacent to the intersecting portions.

5. The display panel according to claim 1, wherein the third spacers outnumber the at least one second spacer.

6. The display panel according to claim 1, wherein:
among the pixel sections, the first pixel sections and the second pixel sections are repeatedly arranged in a prescribed order in a row direction, whereas either the first pixel sections or the second pixel sections are repeatedly arranged in a column direction; and
the at least one second spacer and the third spacers are arranged in a fixed manner in the row and column directions of the pixel sections, to form a lattice.

7. The display panel according to claim 1, wherein:
among the pixel sections, the first pixel sections and the second pixel sections are repeatedly arranged in a prescribed order in a row direction, whereas either the first pixel sections or the second pixel sections are repeatedly arranged in a column direction; and
the at least one second spacer and the third spacers are arranged in a fixed manner in the row direction of the pixel sections and in a staggered manner by being displaced by a prescribed amount in the column direction.

8. The display panel according to claim 6, wherein the first spacers are provided in locations where some of the at least one second spacer are replaced.

9. The display panel according to claim 1, wherein those inter-pixel-section light-blocking sections that are adjacent to the pixel sections facing the first spacers include no second spacer.

10. The display panel according to claim 1, wherein for each of the pixels, a fixed total number of the first spacers and the at least one second spacer is provided in the inter-pixel-section light-blocking section adjacent to the pixel sections in that pixel.

11. The display panel according to claim 1, wherein:
the pixel sections further include third pixel sections that give off a different color than do the first pixel sections and the second pixel sections;
the first pixel sections contribute more to panel transmittance than do the second pixel sections and the third pixel sections; and
the first spacers are provided in those inter-pixel-section light-blocking sections that are adjacent to either the second pixel sections or the third pixel sections.

12. The display panel according to claim 11, wherein the at least one second spacer is provided in those inter-pixel-section light-blocking sections that are adjacent to either the second pixel sections or the third pixel sections.

13. A display device comprising the display panel according to claim 1.
